(19) United States
(12) Patent Application Publication
(10) Pub. No.: US 2025/0068672 A1
(43) Pub. Date: Feb. 27, 2025

(54) DATA PROCESSING AND ENTITY LINKING

(71) Applicant: Tencent Technology (Shenzhen) Company Limited, Shenzhen (CN)

(72) Inventors: Zifei SHAN, Shenzhen (CN); Yuxin LI, Shenzhen (CN); Qian CHEN, Shenzhen (CN)

(73) Assignee: Tencent Technology (Shenzhen) Company Limited, Shenzhen (CN)

(21) Appl. No.: 18/943,839

(22) Filed: Nov. 11, 2024

Related U.S. Application Data
(63) Continuation of application No. PCT/CN2023/124915, filed on Oct. 17, 2023.

(30) Foreign Application Priority Data
Nov. 8, 2022 (CN) 202211391389.8

(51) Int. Cl. G06F 16/45; G06F 16/41; G06F 16/432

(52) U.S. Cl. CPC G06F 16/45; G06F 16/41; G06F 16/432

(57) ABSTRACT

In a data processing method, a first training sample is received. The first training content data is encoded by using a first context encoding model to obtain a first context feature representation corresponding to the first training entity. The first semantic feature data is encoded by using a to-be-trained first entity encoding model to obtain a first semantic feature representation corresponding to the first training entity. A first feature representation loss is determined based on first similarity information between the first context feature representation and the first semantic feature representation. First model parameters of the to-be-trained first entity encoding model are adjusted based on the first feature representation loss to obtain a trained first entity encoding model. Apparatus and non-transitory computer-readable storage medium counterpart embodiments are also contemplated.

### RELATED APPLICATIONS

The present application is a continuation of International Application No. PCT/CN2023/124915, filed on Oct. 17, 2023, which claims priority to Chinese Patent Application No. 202211391389.8, filed on Nov. 8, 2022. The entire disclosures of the prior applications are hereby incorporated by reference.

### FIELD OF THE TECHNOLOGY

This application relates to the field of computer technologies, including data processing and entity linking.

### BACKGROUND OF THE DISCLOSURE

With the development of computer technologies, an entity linking technology appears, and entity linking is also referred to as entity resolution and entity disambiguation, and refers to a process in which a phrase that may be referred to as an entity is recognized in a text or multi-modal content, and is corresponding to a non-ambiguous entity in a knowledge graph.

In a related technology, when entity linking processing is performed on a text or multi-modal content, a semantic feature representation needs to be generated for an entity in a knowledge graph. However, a problem of low accuracy of the generated semantic feature representation often exists.

### SUMMARY

According to various embodiments of this disclosure, a data processing method, an entity linking method, and an apparatus are provided.

Examples of technical solutions in the embodiments of this disclosure may be implemented as follows.

An aspect of this disclosure provides a data processing method. A first training sample is received. The first training sample includes first semantic feature data associated with a first training entity and first training content data associated with the first training entity. The first semantic feature data includes first semantic information of the first training entity, and the first training content data includes first context information of the first training entity. The first training content data is encoded by using a first context encoding model to obtain a first context feature representation corresponding to the first training entity. The first semantic feature data is encoded by using a to-be-trained first entity encoding model to obtain a first semantic feature representation corresponding to the first training entity. A first feature representation loss is determined based on first similarity information between the first context feature representation and the first semantic feature representation. First model parameters of the to-be-trained first entity encoding model are adjusted based on the first feature representation loss to obtain a trained first entity encoding model.

An aspect of this disclosure provides an entity linking method. Target content data is determined. Entity word recognition is performed on the target content data to obtain a target entity mention. The target content data is encoded to obtain a target context feature representation corresponding to the target entity mention. Based on a pre-established mapping relationship between an entity mention and an entity in a target knowledge graph, at least one candidate entity corresponding to the target entity mention is determined. For each candidate entity, a target semantic feature representation corresponding to the respective candidate entity is obtained. The target semantic feature representation is obtained based on an initial semantic feature representation, and the initial semantic feature representation is obtained by encoding candidate semantic feature data of the respective candidate entity using a trained first entity encoding model. A candidate confidence for each candidate entity is determined based on target similarity information between the target context feature representation and the target semantic feature representation of each candidate entity. A target entity corresponding to the target entity mention from the at least one candidate entity is determined based on the candidate confidence of each candidate entity.

An aspect of this disclosure provides an apparatus. The apparatus includes processing circuitry configured to receive a first training sample. The first training sample includes first semantic feature data associated with a first training entity and first training content data associated with the first training entity. The first semantic feature data includes first semantic information of the first training entity, and the first training content data includes first context information of the first training entity. The processing circuitry is configured to encode the first training content data by using a first context encoding model to obtain a first context feature representation corresponding to the first training entity. The processing circuitry is configured to encode the first semantic feature data by using a to-be-trained first entity encoding model to obtain a first semantic feature representation corresponding to the first training entity. The processing circuitry is configured to determine a first feature representation loss based on first similarity information between the first context feature representation and the first semantic feature representation. The processing circuitry is configured to adjust first model parameters of the to-be-trained first entity encoding model based on the first feature representation loss to obtain a trained first entity encoding model.

Details of one or more embodiments of this disclosure are provided in the accompanying drawings and descriptions below. Other features, objectives, and advantages of this disclosure become apparent from the specification, the accompanying drawings, and the claims.

### BRIEF DESCRIPTION OF THE DRAWINGS

To describe technical solutions in embodiments of this disclosure, the following briefly introduces the accompanying drawings required for describing the embodiments or the related technology. The accompanying drawings in the following description show embodiments of this disclosure, and a person of ordinary skill in the art may still derive other drawings from the accompanying drawings.

FIG. 1 is an application environment diagram of a data processing method and an entity linking method according to an embodiment.

FIG. 2 is a schematic diagram of an example of a relationship between an entity and a text in a knowledge graph according to an embodiment.

FIG. 3 is a schematic diagram of a process of entity linking according to an embodiment.

FIG. 4 is a schematic flowchart of a data processing method according to an embodiment.

FIG. 5 is a schematic diagram of a two-tower model according to an embodiment.

FIG. 6 is a schematic diagram of a two-tower model according to another embodiment.

FIG. 7 is a schematic diagram of a two-tower model according to still another embodiment.

FIG. 8 is a schematic flowchart of an operation of generating a target semantic feature representation according to an embodiment.

FIG. 9 is a schematic flowchart of an entity linking method according to an embodiment.

FIG. 10 is a schematic diagram of establishing and storing a mapping relationship according to an embodiment.

FIG. 11 is a diagram of a technical architecture related to an entity linking method according to an embodiment.

FIG. 12 is a schematic diagram of a reasoning process of an entity linking reasoning module according to an embodiment.

FIG. 13 is a schematic diagram of constructing a user interest tag by using an entity linking system in an embodiment.

FIG. 14 is a structural block diagram of a data processing apparatus according to an embodiment.

FIG. 15 is a structural block diagram of an entity linking apparatus according to an embodiment.

FIG. 16 is an internal structural diagram of a computer device according to an embodiment.

FIG. 17 is an internal structural diagram of a computer device according to an embodiment.

### DESCRIPTION OF EMBODIMENTS

The technical solutions in embodiments of this disclosure are described in the following with reference to the accompanying drawings in the embodiments of this disclosure. The described embodiments are merely some rather than all of the embodiments of this disclosure. All other embodiments obtained by a person of ordinary skill in the art based on the embodiments of this disclosure shall fall within the protection scope of this disclosure.

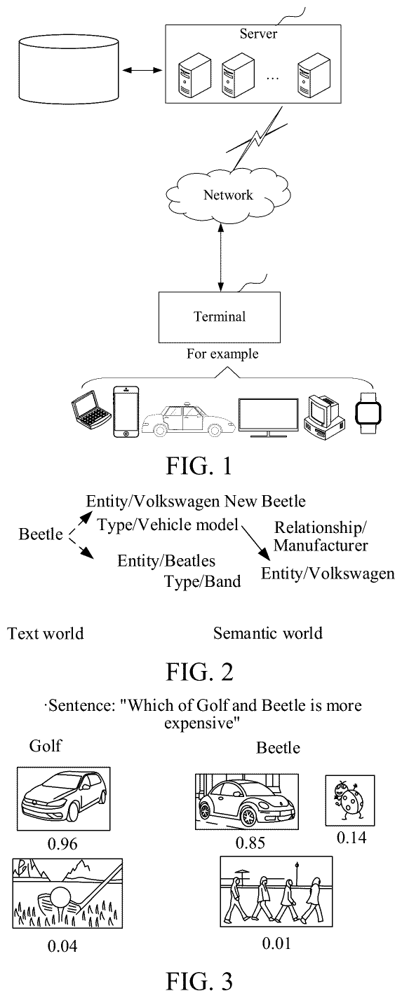

A data processing method and an entity linking method provided in the embodiments of this disclosure may be applied to an application environment shown in FIG. 1. A terminal 102 communicates with a server 104 by using a model. A data storage system may store data that needs to be processed by the server 104. The data storage system may be integrated on the server 104, or may be placed on a cloud or another server. The data storage system may store training sample data. The terminal 102 and the server 104 may separately perform the data processing method and the entity linking method provided in the embodiments of this disclosure. The terminal 102 and the server 104 may alternatively cooperatively perform the data processing method and the entity linking method of this disclosure. For example, the server 104 may obtain a first training sample, where the first training sample includes semantic feature data and training content data that are corresponding to the first training entity, the semantic feature data includes semantic information of a first training entity, and the training content data includes context information of the first training entity. The server may further encode the training content data by using a first context encoding model to obtain a first context feature representation corresponding to the first training entity, encode the semantic feature data by using a to-be-trained first entity encoding model to obtain a first semantic feature representation corresponding to the first training entity, and may determine a first feature representation loss based on a similarity between the first context feature representation and the first semantic feature representation. Further, the server may perform model training based on the loss until training is completed, and obtain a trained first entity encoding model. The server may send the trained first entity encoding model to the terminal 102, so that the terminal 102 can generate a semantic feature representation of the entity by using the trained first entity encoding model to implement entity linking.

The terminal 102 may be but is not limited to various desktop computers, laptops, smartphones, tablet computers, Internet of Things devices, and portable wearable devices. The Internet of Things device may be an intelligent sound box, an intelligent television, an intelligent air conditioner, an intelligent in-vehicle device, or the like. The portable wearable device may be a smart watch, a smart band, a head-mounted device, or the like. The server 104 may be implemented by using an independent server or a server cluster that includes multiple servers.

The data processing method and the entity linking method provided in the embodiments of this disclosure may be implemented based on a knowledge graph. The data processing method is configured for processing entity-related data in the knowledge graph, so as to obtain, by training, an entity encoding model that can be configured for encoding content data corresponding to an entity. The entity encoding model obtained through training may be applied to the entity linking method.

The entity is an object that exists in the objective world. The entity may be an organic body or an inorganic body, and may be a natural or artificial object. The organic body may be a living object, for example, may be an animal, a plant, or a person. The inorganic body may be an inanimate object, such as a machine or a commodity. The natural object may be an object naturally existing in the natural world, for example, may be a mountain, a river, or the like. The artificial object may be an artificially formed object, for example, may be clothing or a vehicle. In this disclosure, a knowledge graph (KG) may be configured for representing an entity. The knowledge graph is graph structure data, a node in the knowledge graph may be configured for representing an entity, and an edge in the knowledge graph is configured for representing a relationship between entities.

In this disclosure, the entity in the knowledge graph may be a node that represents an entity in the knowledge graph. A knowledge graph in which an entity is located may represent a knowledge graph in which a node of the entity is located, that is, a node that represents the entity exists in the knowledge graph. For example, a knowledge graph Y in which an entity A is located may be that a node that represents the entity A exits in the knowledge graph Y. In addition, a knowledge graph corresponding to an entity may also be a knowledge graph in which a node that represents the entity is located, that is, a node that represents the entity exists in the knowledge graph. Similarly, a knowledge graph containing an entity may be a knowledge graph containing a node that represents the entity.

FIG. 2 is a schematic diagram of an example of a relationship between an entity and a text in a knowledge graph according to an embodiment. It can be learned from FIG. 2 that the knowledge graph is a heterogeneous graph structure with multiple entities, relationships, and attributes. Referring to FIG. 2, a relationship between a knowledge graph and a text may be described by using the following example: The term “beetle” is a representation in the text world that may correspond to an insect, a car model, or a band name in different contexts. Entities in two knowledge graphs “The Beatles” and “Volkswagen New Beetle” are representations of the word “beetle” in the text world in the semantic world. In the knowledge graph, the relationship between the entity “Volkswagen New Beetle” and another entity “Volkswagen” is as follows: “Volkswagen” is the manufacturer of “Volkswagen New Beetle”. Recognizing a correct entity that a word refers to in a particular context is the problem to be solved by entity linking. Construction of a high-quality entity linking system helps to accurately understand content of articles, videos, and user searches. It is of great significance to recommendation, search, and advertisement systems.

Entity linking usually has three independent operations. Referring to FIG. 3, a sentence “which of Golf and Beetle is more expensive” is used as an example. The first operation is to perform mention detection, and detect two entity mentions in this sentence: “Golf” and “Beetle”. The second operation is to generate candidate generation of entities in some KGs according to the two entity mentions: Golf may be a car or a sport. Beetle may be an insect, a car, or a band. The last operation is to perform entity disambiguation (or scoring) for the existing candidate generation, and return a high score result to a downstream task. In the following embodiments, the entity linking method provided in this disclosure is specifically described.

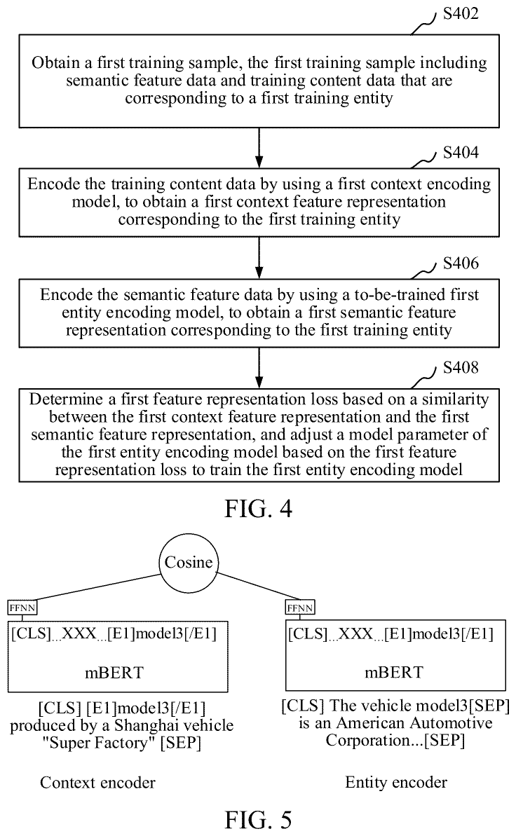

In an embodiment, as shown in FIG. 4, a data processing method is provided. An example in which the method is applied to a computer device is configured for description. The computer device may be the terminal 102 in FIG. 1, may be the server 104 in FIG. 1, or may be a system including the terminal 102 and the server 104. The data processing method includes the following operations:

Operation 402: Obtain a first training sample. The first training sample includes semantic feature data and training content data that are corresponding to a first training entity. For example, a first training sample is received. In an example, the first training sample includes first semantic feature data associated with a first training entity and first training content data associated with the first training entity.

The first training entity is an entity in a knowledge graph, and may be any entity in the knowledge graph. The semantic feature data corresponding to the first training entity includes semantic information of the first training entity, and the semantic information is mainly configured for describing semantic of the entity. Semantic information described in the semantic feature data corresponding to the first training entity may distinguish the first training entity from another entity in terms of semantics. The training content data corresponding to the first training entity includes context information of the first training entity, where the context information is configured for describing a language environment of an entity in a use process, and includes context information of the entity in a language use process. The semantic feature data corresponding to the first training entity may include context information corresponding to the first training entity. Similarly, the training content data corresponding to the first training entity may also include semantic information corresponding to the first training entity.

The semantic feature data corresponding to the first training entity may be specifically data that includes a semantic feature of the first training entity. The semantic feature data corresponding to the first training entity may be obtained from a knowledge graph in which the first training entity is located, and may include at least one of a name of the first training entity, a text description, a main context segment in which the first training entity appears, a relationship between the first training entity and another entity, or an identity (ID) of the entity. When the semantic feature data includes the foregoing multiple types, the semantic feature data may be concatenated to form a text feature string. For example, semantic feature data corresponding to an entity “Metro Line 13” may be: Beijing Metro Line 13, also known as Beijing Urban Railway, is referred to as “Metro”.

The training content data corresponding to the first training entity may be corpus data of various modes, for example, may include at least one of text data, audio data, or video data. There is an entity linking relationship between the training content data corresponding to the first training entity and the training entity, that is, the training content data may be directed to the first training entity by using entity linking. For example, when the training content data is text data, and the text data includes an entity mention corresponding to the first training entity, there is an entity linking relationship between the training content data and the first training entity.

In an embodiment, the computer device may obtain, from a pre-established seed entity linking database, content data corresponding to the first training sample as the training content data. The seed entity linking database pre-stores a known mapping of content data such as a video and a text to an entity in a knowledge graph. The training content data that has an entity linking relationship with the first training entity may be obtained by querying content data that has a mapping relationship with the first training entity in the seed entity linking database. In other embodiments, the computer device may obtain high-confidence text-to-entity mapping data by combining linked corpus data such as encyclopedia data and manual annotation data, so as to obtain the training content data of the first training entity.

Operation 404: Encode the training content data by using a first context encoding model, to obtain a first context feature representation corresponding to the first training entity. For example, the first training content data is encoded by using a first context encoding model to obtain a first context feature representation corresponding to the first training entity.

Operation 406: Encode the semantic feature data by using a to-be-trained first entity encoding model, to obtain a first semantic feature representation corresponding to the first training entity. For example, the first semantic feature data is encoded by using a to-be-trained first entity encoding model to obtain a first semantic feature representation corresponding to the first training entity.

The context encoding model (mention encoder) is a model configured for encoding context information of an entity, and the entity encoding model (entity encoder) is a model configured for encoding semantic information of an entity.

In an embodiment, the context encoding model and the semantic encoding model may be configured for forming a two-tower model. In the two-tower model, an input received by the context encoding model is the training content data of the training entity. Because the training content data is linked to the training entity, the training content data includes context information of the training entity, and may be used as an input to the context encoding model. The input received by the entity encoding model is semantic feature data of the training entity. By training the left tower model and the right tower model in the two-tower model, a trained context encoding model and a trained entity encoding model can be obtained. The trained context encoding model may be used separately, and may be configured for encoding context information alone. The trained entity encoding model may also be used separately, and may be configured for encoding semantic information alone. The computer device may input the training content data in the first training sample into the to-be-trained first context encoding model, encode the training content data by using the first context encoding model to obtain the first context feature representation corresponding to the first training entity, input the semantic feature data in the first training sample into the to-be-trained first entity encoding model, and encode the semantic feature data by using the first entity encoding model to obtain the first semantic feature representation corresponding to the first training entity.

In an embodiment, FIG. 5 is a schematic diagram of a two-tower model used in this disclosure. In this embodiment, the left tower model is a context encoder (mention encoder), and the context encoder may use a multi-layer attention encoder model based on a multilingual BERT (mBERT) structure. The right tower model is an entity encoder, and may also use a multilingual BERT (mBERT) structure. The mBERT is pre-trained based on corpus in multiple different languages, so that a unified encoding space represented by a multi-language entity can be obtained. An input to the left tower model is text data corresponding to the first training entity. For example, text data “[CLS][E1]model3[/E1] produced by a vehicle “super factory” of Shanghai [SEP]” corresponding to the first training entity “Xmodel3” may be inputted, and the text data includes an entity mention “model3” of the first training entity “Xmodel3.” The so-called context encoding may also be understood as encoding an entity mention therein with reference to context information in the text data. An input to the right tower model is the semantic feature data corresponding to the first training entity. For example, “[CLS]Xmodel3[SEP] is an American Automotive Corporation . . . [SEP]” may be inputted.

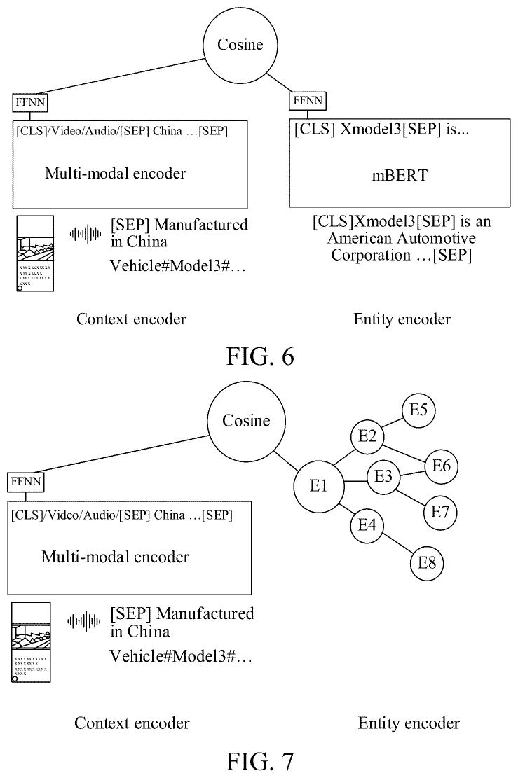

In an embodiment, FIG. 6 is a schematic diagram of a two-tower model used in this disclosure. In this embodiment, the left tower model is a context encoder, and a multi-modal encoding model (Multimodal Encoder) is used. An input to the left tower model may be content data of multiple modals. There is an entity linking relationship between the content data and the training entity, including at least one of video data, voice data, or text data, and cross-modal encoding may be implemented. The right tower model is an entity encoder, and uses mBert obtained through training based on a corpus of multiple languages. For example, as shown in FIG. 6, an input to the left tower model may be training content data corresponding to the first training entity “Xmodel3”, including text data “[SEP] China manufactured vehicle #Model3 # . . . ”, audio data, and video data. An input to the right tower model is semantic feature data “[CLS]Xmodel3[SEP] is an American automotive company . . . [SEP]” corresponding to “Xmodel3”.

In an embodiment, FIG. 7 is a schematic diagram of a two-tower model used in this disclosure. In this embodiment, the left tower model is a context encoder, and a multi-modal encoding model (Multimodal Encoder) is used. An input to the left tower model may be content data of multiple modals. There is an entity linking relationship between the content data and the training entity, including at least one of video data, voice data, or text data, and cross-modal encoding may be implemented. The right tower model is an entity encoder, and an input to the right tower model is a knowledge sub-graph corresponding to the training entity, that is, a graph formed by the training entity and an associated entity corresponding to the training entity. For example, a full first-order relationship and a full second-order relationship of the entity are pulled out from the knowledge graph, and a sub-graph is constructed for an involved entity. Each node in the sub-graph is vector initialized and inputted to the right tower model. The right tower model may use a graph neural network, for example, may use one of a graph convolution network (GCN), a graph attention network (GAN), a graph autoencoder, a graph generative network, or a graph spatio-temporal network, and a feature representation of another node in the sub-graph may be propagated to a node corresponding to the training entity by using the graph neural network.

In an embodiment, the first context encoding model may be a trained model. The trained first context encoding model may output a first context feature representation to the first training entity, so as to assist training of the to-be-trained first entity encoding model. Because the first context encoding model is a trained model, only a model parameter of the semantic encoding model needs to be adjusted in a training process, and training efficiency is higher.

Operation 408: Determine a first feature representation loss based on a similarity between the first context feature representation and the first semantic feature representation, and adjust a model parameter of the first entity encoding model based on the first feature representation loss to train the first entity encoding model. For example, a first feature representation loss is determined based on first similarity information between the first context feature representation and the first semantic feature representation. First model parameters of the to-be-trained first entity encoding model is adjusted based on the first feature representation loss to obtain a trained first entity encoding model.

In an embodiment, the trained first entity encoding model is configured for generating a corresponding target semantic feature representation for each entity in a target knowledge graph, and each target semantic feature representation is configured for performing entity linking processing on target content data. Herein, the target knowledge graph and the knowledge graph in which the first training entity is located may be the same knowledge graph, or may be different knowledge graphs. The target knowledge graph may be further obtained by updating the knowledge graph in which the first training entity is located. For example, some entities and relationships are added to the knowledge graph in which the first training entity is located to obtain the target knowledge graph.

In an embodiment, the computer device may calculate the similarity between the first context feature representation and the first semantic feature representation, so as to obtain the first feature representation loss, adjust a model parameter of the two-tower model based on the first feature representation loss, use the adjusted two-tower model as a to-be-trained two-tower model, obtain a new training sample, and continue to perform iterative training. When a training stop condition is met, training is completed, and a trained two-tower model is obtained, so that the trained first entity encoding model can be obtained. Herein, the training stop condition may be one of: training duration reaches preset duration, a quantity of iterations reaches preset times, a first feature representation loss reaches a minimum value, or the like.

In a training process, a purpose of adjusting the model parameter of the two-tower model is to reduce a loss obtained in the training process, that is, the training process is to adjust the model parameter of the two-tower model to reduce the loss. Therefore, after obtaining the loss by means of calculation, the computer device may calculate, by using a preset algorithm, an updated value of each parameter that needs to be updated in the two-tower model according to the calculated loss, and then replace a current value of the parameter in the model with the updated value obtained by means of calculation, so as to update the model parameter. For example, the preset algorithm may use a gradient (derivative) of the parameter as a clue, and update the parameter in a gradient direction. Each time the parameter is updated, a loss obtained in a next training process may be reduced, and the parameter gradually approaches an optimal parameter after multiple times of repetition. In a specific application, the preset algorithm may be any one of a random gradient descent algorithm, an adaptive gradient (Adagrad) algorithm, an improvement of the AdaGrad algorithm (Adadelta), an improvement of the AdaGrad algorithm (RMSprop), an adaptive moment estimation (Adam) algorithm, or the like.

The similarity between the first context feature representation and the first semantic feature representation is configured for indicating a similarity or a degree of difference between the first context feature representation and the first semantic feature representation. In an embodiment, the computer device may calculate a cosine similarity between the first context feature representation and the first semantic feature representation to obtain the first feature representation loss, a cosine similarity is configured for measuring an included angle cosine value between two vectors, with a value range of [−1, 1], where 1 represents completely similar, and −1 represents completely dissimilar. In another embodiment, the computer device may calculate a vector distance between the first context feature representation and the first semantic feature representation. The vector distance may be, for example, a Euclidean distance or a Manhattan distance. The Euclidean distance is configured for measuring a Euclidean distance between two vectors, that is, square rooting of a square sum of difference between elements of the two vectors, with a value range of [0, +∞), where 0 represents completely the same. The Manhattan distance is configured for measuring a Manhattan distance between two vectors, that is, a sum of absolute values of differences between elements of the two vectors, with a value range of [0, +∞), where 0 represents completely the same.

In an embodiment, the training content data included in the first training sample has an entity linking relationship with the first training entity. Therefore, the first training sample is a positive sample. In a process of learning of the positive sample, a training objective of the two-tower model is to make an output of the left tower model and an output of the right tower model similar. For example, a cosine similarity between the output of the left tower model and the output of the right tower model may be calculated, so that a value of the cosine similarity is as close as possible to 1. In another embodiment, the computer device may further obtain a negative sample for training. In the negative sample, there is no entity linking relationship between the training content data and the first training entity, that is, training content data in the negative sample does not point to the first training entity after undergoing entity linking. In a process of learning of the negative sample, a training objective of the two-tower model is to make an output of the left tower model and an output of the right tower model dissimilar. For example, a cosine similarity between the output of the left tower model and the output of the right tower model may be calculated, so that a value of the cosine similarity is as close to −1 as possible.

In an embodiment, when the first context encoding model and the first entity encoding model form a two-tower model for joint training, and when training is completed, a trained first context encoder may be further obtained, and the trained first context encoder may be configured to perform context encoding on content data to which an entity linking is to be performed in a process of entity linking, to obtain a context feature representation, and then perform entity linking based on the context feature representation.

In an embodiment, the trained first entity encoding model may be directly used. For each entity in the target knowledge graph, a corresponding target semantic feature representation is generated. For example, for an entity in the target knowledge graph, corresponding semantic feature data may be obtained from the target knowledge graph, and then the semantic feature data is inputted into the trained first entity encoding model. The trained first entity encoding model encodes the inputted semantic feature data to obtain the target semantic feature representation of the entity.

In an embodiment, in obtaining the target semantic feature representation of each entity in the target knowledge graph, the computer device may establish a mapping relationship between the entity and the target semantic feature representation, and perform entity linking processing on to-be-entity-linked content data based on the mapping relationship.

In the foregoing data processing method, the first training sample is obtained, where the training sample includes the semantic feature data and the training content data that are corresponding to the first training entity, the semantic feature data includes the semantic information of the first training entity, the training content data includes the context information of the first training entity, and the training content data is encoded by using the first context encoding model to obtain the first context feature representation corresponding to the first training entity. The first semantic feature representation corresponding to the first training entity may be obtained by encoding the semantic feature data by using the to-be-trained first entity encoding model, and the first semantic feature representation loss is determined based on the first context feature representation and the first semantic feature representation. Therefore, the trained first entity encoding model may be obtained based on the loss. Because the entity encoding model determines the loss by using the context feature representation outputted by the context encoding model in the training process, the entity encoding model can not only learn of the semantic information, but also learn of the context information. Therefore, when the target entity encoding model is configured for generating a target semantic feature representation for an entity, a more accurate semantic feature representation may be obtained.

In an embodiment, when the semantic feature data inputted in the entity encoding model training process is obtained from the knowledge graph, the obtained semantic feature data is more flexible. When the knowledge graph is updated, the semantic feature data of the entity may be updated. The semantic feature representation of the new entity does not depend on a large quantity of training data for the new entity, and can be obtained only by using the semantic feature data of the new entity. Therefore, a continuously updated knowledge graph can be well adapted.

In an embodiment, when the training content data is a training text, the training text includes an entity mention corresponding to the first training entity. The encoding the training content data by using a to-be-trained first context encoding model, to obtain a first context feature representation corresponding to the first training entity includes: adding a boundary mark to the entity mention in the training text to obtain a target training text; inputting the target training text into the first context encoding model, and encoding the target training text by using the first context encoding model, to obtain a context feature representation corresponding to the first training entity.

The training text refers to a text that has an entity linking relationship with the first training entity. The boundary mark refers to a symbol that can mark an entity mention, and a symbol used by the boundary mark may be customized. For example, in the example shown in FIG. 5, for an input text “[CLS] [E1] model3[/E1] produced by a Shanghai vehicle “Super Factory [SEP]” of the context encoder, a previous character [E1] and a subsequent character [/E1] of “model3” constitute a boundary mark, and an entity mention “model3” may be marked by using the boundary mark.

Considering that when encoding a text, the encoder is usually based on a word level, but in the Chinese field, phrases contain more abundant information and semantics than words. To enable the encoder to learn of more accurate context information, in this embodiment, the computer device may add a boundary mark to an entity mention in a training text to obtain a target training text, and then may input the target training text added with the boundary mark to the to-be-trained first context encoding model, where the first context encoding model may encode the entity mention as a whole when encoding the target training text, so that more abundant semantic information can be obtained. In addition, in the text inputted into the context encoder, in addition to the entity mention corresponding to the first training entity, there may also be entity mention of another entity. By performing boundary marking on the entity mention corresponding to the first training entity, the first context encoding model may pay more attention to learning of the entity mention in a learning process, so as to learn of context information with a greater relevance to the entity mention, so that a context feature representation obtained by encoding has a higher relevance to the first training entity, and context information learned by the entity encoding model is more accurate.

In an embodiment, when the training content data inputted into the context encoding model is a text, in a specific application, training may be performed by using the two-tower model shown in FIG. 5.

In the foregoing embodiment, by adding a boundary mark to an entity mention in the training text and then inputting into the first context encoding model, accuracy of the context feature representation outputted by the first context encoding model can be improved. Because the first context encoding model and the first entity encoding model constitute a two-tower model for co-training, accuracy of the semantic feature representation outputted by the first entity encoding model can be improved.

In an embodiment, the training content data is training data in multiple modals, and the training data in multiple modals includes at least two of a training text, a training video, or a training audio. The encoding the training content data by using a first context encoding model, to obtain a first context feature representation corresponding to the first training entity includes: separately inputting the training data in the multiple modals into the first context encoding model; separately encoding the training data in the multiple modals by using the first context encoding model, to obtain content feature representations respectively corresponding to the multiple modals; and fusing the content feature representations respectively corresponding to the multiple modals to obtain a context feature representation corresponding to the first training entity.

The training audio refers to audio data that includes the context information of the first training entity. For example, the training audio may be audio that has an entity linking relationship with the first training entity. The training video refers to video data that includes the context information of the first training entity. For example, the training video may be a video that has an entity linking relationship with the first training entity.

In an embodiment, training data in multiple modals is a training text and a training video. The computer device may input the target training text obtained by performing boundary marking on the training text and the training video together into the to-be-trained first context encoding model, separately encode the target training text and the training video by using the first context encoding model, to obtain a text feature representation corresponding to the target training text and a video feature representation corresponding to the training video, and combine the text feature representation and the video feature representation to obtain the context feature representation corresponding to the first training entity.

In another embodiment, training data in multiple modals is a training text and a training audio. The computer device may input the target training text and the training audio into the to-be-trained first context encoding model, separately encode the target training text and the training audio by using the first context encoding model, to obtain a text feature representation corresponding to the target training text and an audio feature representation corresponding to the training audio, and combine the text feature representation and the audio feature representation to obtain a context feature representation corresponding to the first training entity.

In another embodiment, training data in multiple modals is a training audio and a training video. The computer device may input the training audio and the training video together into the to-be-trained first context encoding model, separately encode the training audio and the training video by using the first context encoding model, to obtain an audio feature representation corresponding to the training audio and a video feature representation corresponding to the training video, and combine the audio feature representation and the video feature representation to obtain a context feature representation corresponding to the first training entity.

In other embodiments, training data in multiple modals is a training text, a training audio, and a training video. The computer device may input the target training text, the training audio, and the training video into the to-be-trained first context encoding model, and separately encode, by using the first context encoding model, the target training text, the training audio, and the training video to obtain a text feature representation corresponding to the target training text, an audio feature representation corresponding to the training audio, and a video feature representation corresponding to the training video. The text feature representation, the audio feature representation, and the video feature representation are fused to obtain a context feature representation corresponding to the first training entity.

The training content data inputted into the context encoding model in this disclosure is multi-modal data. In specific application, training may be performed by using the two-tower model shown in FIG. 6 or FIG. 7.

In the foregoing embodiment, because multi-modal data is input into the context encoding model, a context feature representation with more abundant context information can be obtained by encoding, thereby improving a training effect of the two-tower model, so that the target entity encoding model obtained through training is more accurate, and a more accurate semantic feature representation can be outputted in an application process.

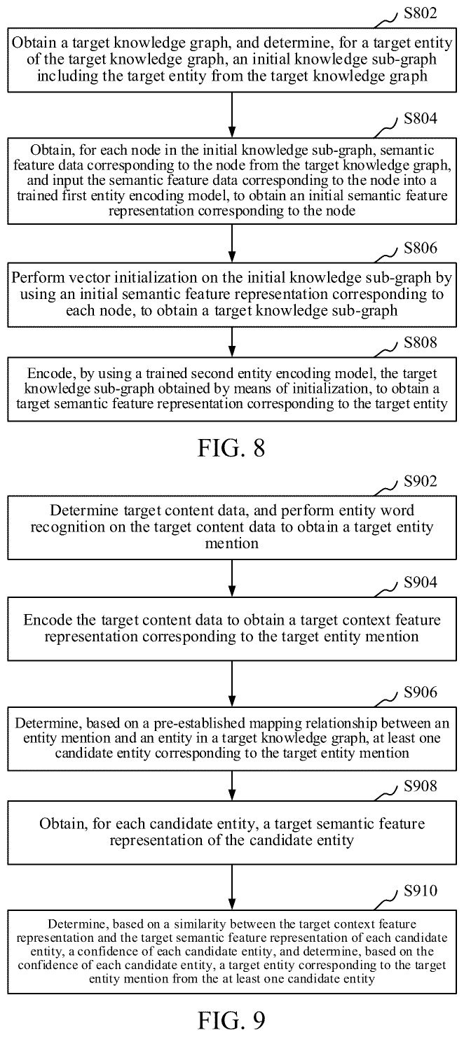

In an embodiment, as shown in FIG. 8, the foregoing data processing method further includes the operation of generating a target semantic feature representation, and specifically includes the following operations 802 to 808:

Operation 802: Obtain a target knowledge graph, and determine, for a target entity of the target knowledge graph, an initial knowledge sub-graph including the target entity from the target knowledge graph. For example, a target entity from a target knowledge graph is received. A target initial knowledge subgraph including the target entity from the target knowledge graph is identified.

The target entity may be any entity in the target knowledge graph. The initial knowledge sub-graph is corresponding to the target entity, and the initial knowledge sub-graph includes the target entity. For example, the initial knowledge sub-graph may be specifically a sub-graph formed by the target entity and an associated entity of the target entity in the target knowledge graph. The associated entity of the target entity refers to an entity that has a direct or indirect association relationship with the target entity, that is, an entity that is directly or indirectly connected to the target entity by using an edge in the knowledge graph.

In an embodiment, for the target entity in the target knowledge graph, the computer device may determine, from the target knowledge graph, associated entities whose relationships with the target node are less than a preset order, and determine a sub-graph formed by the target entity and these associated entities as the initial knowledge sub-graph corresponding to the target entity.

For example, assuming that the preset order is 3, the computer device may determine, from the target knowledge graph, an entity in a first-order relationship with the target node and an entity in a second-order relationship with the target node, where the entity with the first-order relationship is an entity directly connected to the target entity by using an edge, and the entity with the second-order relationship is an entity directly connected to the entity with the first-order relationship by using an edge.

Operation 804: Obtain, for each node in the initial knowledge sub-graph, semantic feature data corresponding to the node from the target knowledge graph, and input the semantic feature data corresponding to the node into a trained first entity encoding model, to obtain an initial semantic feature representation corresponding to the node. For example, for each target node in the target initial knowledge subgraph, target semantic feature data corresponding to the respective target node from the target knowledge graph is extracted. The target semantic feature data corresponding to the respective target node is inputted into the trained first entity encoding model to obtain a target initial semantic feature representation corresponding to the respective target node.

Operation 806: Perform vector initialization on the initial knowledge sub-graph by using an initial semantic feature representation corresponding to each node, to obtain a target knowledge sub-graph. For example, target vector initialization is performed on the target initial knowledge subgraph using the target initial semantic feature representation corresponding to each target node to obtain a target knowledge subgraph.

In an embodiment, for each node in the initial knowledge sub-graph, the computer device may obtain, from the target knowledge graph, semantic feature data corresponding to the node, and then input the semantic feature data into the trained first entity encoding model, so that the trained first entity encoding model can encode the semantic feature data to obtain an initial semantic feature representation corresponding to the node. Further, the computer device may perform vector initialization on each node in the initial knowledge sub-graph by using a respective initial semantic feature representation of each node, to obtain a target knowledge sub-graph, where vector initialization means using the respective initial semantic feature representation of each node as an initial semantic representation corresponding to the initial knowledge sub-graph, that is, the target knowledge sub-graph is a sub-graph represented by the respective initial semantic feature representation of each node.

Operation 808: Encode, by using a trained second entity encoding model, the target knowledge sub-graph obtained by means of initialization, to obtain a target semantic feature representation corresponding to the target entity. For example, the target knowledge subgraph is encoded using a trained second entity encoding model to obtain a target semantic feature representation corresponding to the target entity.

The second entity encoding model is a trained model, and a model parameter of the second entity encoding model is different from the model parameter of the trained first entity encoding model. The second entity encoding model may use a graph neural network, and by using the graph neural network, a feature representation of another node in the sub-graph may be propagated to a node corresponding to the training entity.

In an embodiment, the second entity encoding model may be obtained by training the to-be-trained two-tower model. One tower of the two-tower model is configured for training to obtain the second entity encoding model. An input thereto is a training knowledge sub-graph corresponding to the training entity, and an output thereof is a semantic feature representation corresponding to the training entity. An input to the other tower is training content data corresponding to the training entity, which may be at least one of video data, audio data, or text data. The second entity encoding model herein may be obtained by means of training by the computer device, or may be obtained by the computer device from another computer device, that is, a computer device that trains the second entity encoding model may be different from a computer device that uses the second entity encoding model.

The computer device may input the target knowledge sub-graph into the trained second entity encoding model, and encode the target knowledge sub-graph by using the trained second entity encoding model, to obtain the target semantic feature representation corresponding to the target entity.

In a specific embodiment, the first entity encoding model may be obtained by training the two-tower model shown in FIG. 5 or FIG. 6, and the second entity encoding model may be obtained by training the two-tower model shown in FIG. 7.

In the foregoing embodiment, the initial knowledge sub-graph of the target entity is obtained, the initial semantic representation vector is generated for each node in the initial knowledge sub-graph by using the trained first entity encoding model, so as to initialize the sub-graph, and further, the initialized sub-graph is encoded by using the trained second target entity encoding model, so as to optimize the initial semantic representation vector, so as to obtain a more accurate target semantic feature representation.

In an embodiment, the training operation of the second entity encoding model includes: obtaining a second training sample; the second training sample including a training knowledge sub-graph and training content data that are corresponding to the second training entity; and the training knowledge sub-graph being obtained by performing vector initialization on an initial knowledge sub-graph corresponding to the second training entity, and the initial knowledge sub-graph corresponding to the second training entity being determined from a knowledge graph in which the second training entity is located; encoding, by using a second context encoding model, the training content data corresponding to the second training entity, to obtain a second context feature representation corresponding to the second training entity; encoding the training knowledge sub-graph by using a to-be-trained second entity encoding model, to obtain a second semantic feature representation corresponding to the second training entity; and determining a second feature representation loss based on the second context feature representation and the second semantic feature representation, and adjusting a model parameter of the to-be-trained second entity encoding model based on the second feature representation loss to obtain the trained second entity encoding model.

The second training entity may be any entity in the knowledge graph, the second training entity and the first training entity may be the same entity or may be different entities, and training content data corresponding to the second training entity includes context information of the second training entity. For example, an entity linking relationship exists between the training content data corresponding to the second training entity and the second training entity, and the training content data may be at least one of text data, video data, or audio data.

In an embodiment, a to-be-trained second context encoding model and a to-be-trained second entity encoding model may be configured for forming a two-tower model. After obtaining the second training sample, the computer device may encode the training content data corresponding to the second training entity by using the second context encoding model in the two-tower model to obtain the second context feature representation, encode the training knowledge sub-graph by using the second entity encoding model in the two-tower model to obtain the second semantic feature representation, and calculate the similarity between the second context feature representation and the second semantic feature representation, so as to obtain the second feature representation loss, and adjust model parameters of the two towers in the two-tower model based on the second feature representation loss. When a training stop condition is met, training is completed to obtain a trained two-tower model, so as to obtain the trained second entity encoding model.

In an embodiment, the second context encoding model may be a trained model. The trained second context encoding model may output a second context feature representation to the second training entity, so as to assist training of the to-be-trained second entity encoding model. Because the second context encoding model is a trained model, only a model parameter of the semantic encoding model needs to be adjusted in a training process, and training efficiency is higher.

In an embodiment, after determining, from the knowledge graph of the training entity, the initial knowledge sub-graph corresponding to the second training entity, the computer device may perform random vector initialization on all nodes in the initial knowledge sub-graph, so as to obtain the training knowledge sub-graph corresponding to the second training entity.

In an embodiment, the second context encoding model and the second entity encoding model are co-trained by forming a two-tower model, and when training is completed, a trained second context encoder may be further obtained, and the trained second context encoder may be configured to perform context encoding on content data to which an entity linking is to be performed in a process of entity linking, to obtain a context feature representation, and then perform entity linking based on the context feature representation.

In an embodiment, the obtaining a second training sample includes: determining, for the second training entity, the initial knowledge sub-graph corresponding to the second training entity from the knowledge graph in which the second training entity is located; obtaining, for each node in the initial knowledge sub-graph corresponding to the second training entity, semantic feature data corresponding to the node from the knowledge graph in which the second training entity is located, and inputting the semantic feature data corresponding to the node into a trained first entity encoding model, to obtain an initial semantic feature representation corresponding to the node; performing, by using an initial semantic feature representation corresponding to each node, vector initialization on the initial knowledge sub-graph corresponding to the second training entity, to obtain the training knowledge sub-graph corresponding to the second training entity; and constructing the second training sample corresponding to the second training entity based on the training knowledge sub-graph corresponding to the second training entity and the training content data corresponding to the second training entity.

The initial knowledge sub-graph corresponding to the second training entity refers to a knowledge sub-graph including the second training entity. The initial knowledge sub-graph corresponding to the second training entity may be specifically a sub-graph formed by the second training entity and an associated entity of the second training entity. The associated entity of the second training entity refers to an entity that has a direct or indirect association relationship with the second training entity, that is, an entity that is directly or indirectly connected to the second training entity by using an edge in the knowledge graph.

In an embodiment, after determining the initial knowledge sub-graph corresponding to the second training entity, the computer device may generate, by using the trained first entity encoding model, corresponding initial semantic feature representations for all nodes in the initial sub-graph, and further perform vector initialization on the initial knowledge sub-graph by using these initial semantic feature representations to obtain a training knowledge sub-graph. Further, the second training sample corresponding to the second training entity may be constructed by using the training knowledge sub-graph and the training content data corresponding to the second training entity. Compared with performing random initialization on an initial knowledge sub-graph to obtain a training knowledge sub-graph, an initialization vector of each node in the training knowledge sub-graph obtained in this embodiment is more accurate, so that a second entity encoding model obtained through training has better performance.

In an embodiment, the foregoing data processing method further includes: obtaining a third training sample; the third training sample including training content data corresponding to a third training entity; encoding, by using a to-be-trained third context encoding model, the training content data corresponding to the third training entity, to obtain a third context feature representation corresponding to the third training entity; determining a third feature representation loss based on the third context feature representation and a third semantic feature representation corresponding to the third training entity; the third semantic feature representation being obtained by encoding semantic feature data corresponding to the third training entity by using the trained first entity encoding model; and adjusting a model parameter of the third context encoding model based on the third feature representation loss to train the third context encoding model.

The third training entity may be any entity in the knowledge graph. The third training entity, the first training entity, and the second training entity may be the same entity or may be different entities. Training content data corresponding to the third training entity includes context information of the third training entity. For example, the training content data corresponding to the third training entity has an entity linking relationship with the third training entity, and may include at least one of text data, video data, or audio data. The semantic feature data corresponding to the third training entity is obtained from a knowledge graph in which the third training entity is located. The trained first entity encoding model may be the trained first entity encoding model obtained in any one of the foregoing embodiments.

The computer device may encode the inputted training content data by using the to-be-trained third context encoding model, to obtain a third context feature representation corresponding to the third training entity, and may further calculate a similarity between the third context feature representation and the third semantic feature representation to obtain a third feature representation loss, and adjust a model parameter of the third context encoding model based on the third feature representation loss and continue training until training is completed, to obtain a trained third context encoding model.

In a specific embodiment, the training content data in the third training sample may be obtained in any one of the following two manners: 1. Parse, process, and match links in encyclopedia data or other linked corpus data to obtain a mapping of content data to an entity, and obtain training content data according to the mapping. 2. Filter, by using a rule, an entity name that is not ambiguous in a knowledge graph, and use the obtained entity name to accurately match corpus such as article data and video data, so as to obtain a mapping of content data to an entity, and obtain training content data according to the mapping.

In a specific embodiment, the third training sample may further include semantic feature data corresponding to the third training entity. A to-be-trained third context encoding model may form a two-tower model with a trained context encoding model. In a training process, the training content data is inputted into the third context encoding model, the semantic feature data is inputted into the trained context encoding model, and the third context feature representation is outputted by using the third context encoding model. The third semantic feature representation is outputted by using the trained context encoding model, and a similarity between the third context feature representation and the third semantic feature representation is calculated to obtain a third feature representation loss. The parameter of the third context encoding model is adjusted by using the loss, and the model parameter of the context encoding model is fixed in the entire training process.

In another specific embodiment, to improve training efficiency, a semantic feature representation may be generated in advance for each entity in the knowledge graph by using a trained entity encoding model, and a mapping relationship between the entity and the semantic feature representation is established. Further, in a training process, the third semantic feature representation corresponding to the third training entity may be directly queried, and the third feature representation loss is determined by using the third semantic feature representation and the third context feature representation outputted by the third context encoding model.

In an embodiment, the third context encoding model is configured to generate a corresponding target context feature representation for an entity in the target knowledge graph, and the target context feature representation is configured to perform entity linking processing.

In the foregoing embodiment, the feature representation loss is calculated by using the semantic feature representation generated by the trained target entity encoding model and the third context feature representation outputted by the to-be-trained third context encoding model, to train the third context encoding model, so that better training efficiency can be obtained. When context encoding is performed by the trained third context encoding model, the context feature representation obtained through training is more accurate.

In an embodiment, as shown in FIG. 9, an entity linking method is provided. An example in which the method is applied to a computer device is configured for description. The computer device may be the terminal 102 in FIG. 1, may be the server 104 in FIG. 1, or may be a system including the terminal 102 and the server 104. The entity linking method includes the following operations:

Operation 902: Determine target content data, and perform entity recognition on the target content data to obtain a target entity mention. For example, target content data is determined. Entity word recognition is performed on the target content data to obtain a target entity mention.

The target content data refers to content data on which entity linking processing needs to be performed. Entity word recognition, that is, mention detection, is to recognize a possible entity word (that is, an entity mention) included in the inputted target content data such as an article, a search statement, and a video.

The computer device may recognize the target content data by using one or more of a named entity recognition (NER) model, alias table matching, or manual template matching, to obtain one or more target entity mentions. “more” refers to at least two.

Operation 904: Encode the target content data to obtain a target context feature representation corresponding to the target entity mention. For example, the target content data is encoded to obtain a target context feature representation corresponding to the target entity mention.

In an embodiment, the computer device may encode the target content data by using the trained context encoding model, to obtain the target context feature representation corresponding to the target entity mention. The context encoding model herein refers to a context encoding model that has been trained, and may be any one of the first context encoding model, the second context encoding model, or the third context encoding model in the foregoing embodiment.

Operation 906: Determine, based on a pre-established mapping relationship between an entity mention and an entity in a target knowledge graph, at least one candidate entity corresponding to the target entity mention. For example, based on a pre-established mapping relationship between an entity mention and an entity in a target knowledge graph, at least one candidate entity corresponding to the target entity mention is determined.

In this embodiment, a mapping relationship between an entity mention and an entity in the target knowledge graph is established in advance. Therefore, for each target entity mention, the computer device may obtain, by querying the mapping relationship, at least one candidate entity corresponding to each target entity mention.

Operation 908: Obtain, for each candidate entity, a target semantic feature representation of the candidate entity. For example, for each candidate entity, a target semantic feature representation corresponding to the respective candidate entity is obtained.

The target semantic feature representation is obtained based on an initial semantic feature representation, and the initial semantic feature representation is obtained by encoding, by using a trained first entity encoding model, semantic feature data corresponding to the candidate entity. The trained first entity encoding model may be the first entity encoding model obtained by means of training in any one of the foregoing embodiments.

In an embodiment, the trained first entity encoding model is obtained through training based on the first feature representation loss, the first feature representation loss is determined based on the first context feature representation and the first semantic feature representation, the first context feature representation is obtained by encoding training content data by using the to-be-trained first context encoding model, the training content data belongs to the first training sample corresponding to the first training entity, the training sample further includes semantic feature data corresponding to the first training entity, the first semantic feature representation is obtained by encoding the semantic feature data corresponding to the first training entity by using the to-be-trained first entity encoding model, and the semantic feature data corresponding to the first training entity includes semantic information of the first training entity. The training content data includes context information of the first training entity.

In an embodiment, when the first entity encoding model is being trained, the semantic feature data in the training sample is obtained from the target knowledge graph. Therefore, semantic feature data obtained by encoding a candidate entity by using the trained first entity encoding model may be obtained from the knowledge graph, and the semantic feature data of the candidate entity is obtained from the knowledge graph and inputted into the trained first entity encoding model, to obtain an initial semantic feature representation corresponding to the candidate entity.

In an embodiment, for each candidate entity, the computer device may input the semantic feature data corresponding to the candidate entity into the trained first entity encoding model, and encode the semantic feature data by using the trained first entity encoding model to obtain an initial semantic feature representation corresponding to the candidate entity, so as to obtain the target semantic feature representation of the candidate entity based on the initial semantic feature representation.

In another embodiment, to improve entity linking efficiency, the computer device may pre-generate a target semantic feature representation for each entity in the target knowledge graph, and store a mapping relationship between the entity and the target semantic feature representation. Therefore, in an entity linking process, the computer device may directly query the mapping relationship to obtain the target semantic feature representation of each target entity.

In an embodiment, after obtaining the initial semantic feature representation corresponding to the candidate entity, the computer device may directly use the initial semantic feature representation as the target semantic feature representation of the candidate entity.

Operation 910: Determine, based on a similarity between the target context feature representation and the target semantic feature representation of each candidate entity, a confidence of each candidate entity, and determine, based on the confidence of each candidate entity, a target entity corresponding to the target entity mention from the at least one candidate entity. For example, a candidate confidence for each candidate entity is determined based on target similarity information between the target context feature representation and the target semantic feature representation of each candidate entity. A target entity corresponding to the target entity mention from the at least one candidate entity is determined based on the candidate confidence of each candidate entity.

The confidence is configured for representing a credibility degree of a candidate entity, and a higher confidence represents a greater credibility degree of the candidate entity, so that the candidate entity is also more likely to be a target entity.

The computer device may separately calculate a similarity between the target context feature representation and the target semantic feature representation of each candidate entity, determine a confidence of each candidate entity based on the similarity obtained by each candidate entity by means of calculation, and further select, according to the confidence, the target entity from the candidate entity corresponding to the target entity mention to obtain the target entity.

In an embodiment, after obtaining the similarity of each candidate entity by means of calculation, the computer device may determine the similarity of each candidate entity as the confidence of each candidate entity. In other embodiments, the computer device may further obtain a confidence coefficient of each candidate entity, and obtain a confidence after multiplying the confidence coefficient by the similarity.

In a specific embodiment, for each target entity mention, the computer device may use, as the target entity, a candidate entity with a highest confidence among candidate entities corresponding to the entity mention.

In the foregoing entity linking method, target content data is determined, entity word recognition is performed on the target content data to obtain a target entity mention, and the target content data is encoded to obtain a target context feature representation corresponding to the target entity mention. At least one candidate entity corresponding to the target entity mention is determined based on a pre-established mapping relationship between an entity mention and an entity in a target knowledge graph. For each candidate entity, a target semantic feature representation of the candidate entity is obtained. A confidence of each candidate entity is determined based on a similarity between a target context feature representation and the target semantic feature representation of each candidate entity. A target entity corresponding to the target entity mention is determined from the at least one candidate entity based on the confidence of each candidate entity. Because the target context feature representation corresponding to the target entity mention can be obtained, the confidence is determined based on a similarity between the target context feature representation and the target semantic feature representation of each candidate entity, The target entity is determined according to the confidence. Therefore, in this disclosure, context information of the target content data can be fully considered during entity linking, and a more accurate target entity is obtained by matching the context information, thereby improving entity linking accuracy.

The target semantic feature representation of the candidate entity is obtained based on an initial semantic feature representation outputted by the trained first entity encoding model. The trained first entity encoding model cooperates with the context encoding model in a training process, so that the entity encoding model can learn of not only semantic information but also context information. Therefore, when the target entity encoding model is configured for generating the semantic feature representation for the entity, a more accurate semantic feature representation may be obtained. In addition, when a candidate entity is finally selected, a confidence of each candidate entity is determined based on the target context feature representation and the target semantic feature representation of each candidate entity, and the target candidate entity is determined based on the confidence. Therefore, in this disclosure, context information of the target content data may be fully considered during entity linking, and the context information is matched by using a semantic feature representation with a relatively high accuracy, to obtain a more accurate target entity, thereby improving entity linking accuracy.

In an embodiment, the target semantic feature representation of the candidate entity is obtained by using an entity encoding operation, and the entity encoding operation includes: determining a knowledge sub-graph including the candidate entity from the target knowledge graph, to obtain an initial knowledge sub-graph corresponding to the candidate entity; obtaining, for each node in the initial knowledge sub-graph, semantic feature data corresponding to the node from the target knowledge graph; inputting the semantic feature data corresponding to the node into the trained first entity encoding model, to obtain an initial semantic feature representation corresponding to the node; performing vector initialization on the initial knowledge sub-graph by using an initial semantic feature representation corresponding to each node, to obtain a target knowledge sub-graph; and encoding, by using a trained second entity encoding model, the target knowledge sub-graph obtained by means of initialization, to obtain the target semantic feature representation corresponding to the candidate entity.

In this embodiment, for each candidate entity, the computer device first obtains an initial knowledge sub-graph of the candidate entity, so as to generate an initial semantic feature representation for each node in the initial knowledge sub-graph by using the trained first entity encoding model, perform vector initialization on the initial knowledge sub-graph by using each initial semantic feature representation, to obtain a target knowledge sub-graph, and then encode the target knowledge sub-graph by using the second entity encoding model, so that the initial semantic feature representation of the candidate entity can be optimized, to obtain the target semantic feature representation of the candidate entity.

In an embodiment, the training operation of the trained second entity encoding model includes: obtaining a second training sample; the second training sample including a training knowledge sub-graph and training content data that are corresponding to the second training entity; and the training knowledge sub-graph being obtained by performing vector initialization on an initial knowledge sub-graph including the second training entity, and the initial knowledge sub-graph including the second training entity being determined from a knowledge graph in which the second training entity is located; encoding, by using a second context encoding model, the training content data corresponding to the second training entity, to obtain a second context feature representation corresponding to the second training entity; encoding the training knowledge sub-graph by using a to-be-trained second entity encoding model, to obtain a second semantic feature representation corresponding to the second training entity; and determining a second feature representation loss based on the second context feature representation and the second semantic feature representation, and adjusting a model parameter of the to-be-trained second entity encoding model based on the second feature representation loss to obtain the trained second entity encoding model.

The operation of obtaining the second entity encoding model by means of training is the same as the operation of obtaining the second entity encoding model by means of training in the data processing method embodiment, that is, the second entity encoding model herein may use the second entity encoding model obtained by means of training in the foregoing embodiment.

In the foregoing embodiment, the initial semantic feature representation is first generated by using the trained first entity encoding model, and then the initial semantic feature representation is optimized by using the second entity encoding model to obtain the target semantic feature representation, thereby further improving accuracy of the target semantic feature representation.

In an embodiment, the target content data includes a text; and the encoding the target content data to obtain a target context feature representation corresponding to the target entity mention includes: adding a boundary mark to the target entity mention in the text to obtain a target text; and inputting the target text into the trained first context encoding model, and encoding the target text by using the first context encoding model, so as to obtain the target context feature representation corresponding to the target entity mention. The training operation of the first context encoding model in this embodiment is the same as the training operation of the first context encoding model in the data processing method embodiment. That is, the first context encoding model herein may use the first context encoding model obtained through training in the foregoing embodiment.

In an embodiment, the encoding the target content data to obtain a context feature representation corresponding to an entity mention includes: inputting the target content data into a trained third context encoding model; and encoding the target content data by using the trained third context encoding model, to obtain the target context feature representation corresponding to the target entity mention.

In an embodiment, a training operation of the trained third context encoding model includes: obtaining a third training sample; the third training sample including training content data corresponding to a third training entity; the training content data corresponding to the third training entity including context information of the third training entity; encoding, by using a to-be-trained third context encoding model, the training content data corresponding to the third training entity, to obtain a third context feature representation corresponding to the third training entity; determining a third feature representation loss based on the third context feature representation and a third semantic feature representation corresponding to the third training entity; the third semantic feature representation being obtained by encoding semantic feature data corresponding to the third training entity by using the trained first entity encoding model; and adjusting a model parameter of the third context encoding model based on the third feature representation loss to obtain the trained third context encoding model.

The training operation of the third context encoding model is the same as the training operation of the third context encoding model in the data processing method embodiment. That is, the third context encoding model herein may use the third context encoding model obtained through training in the foregoing embodiment.

In an embodiment, the foregoing entity linking method further includes the following operations:

1. Extract multiple entity mentions from a preset content database, and separately determine at least one entity linked to each entity mention from the target knowledge graph.

A mapping between content data in the preset content database and an entity in the knowledge graph is known, that is, an entity linking relationship between the content data in the content database and the entity in the knowledge graph is established in advance.

2. Count, for each entity linked to the entity mention, a quantity of occurrence of the entity in the content database.

3. Count, for an entity mention linked to the entity, a quantity of occurrence of each entity linked to the entity mention to obtain a counting quantity of the entity.

A quantity of times that an entity appears in the content database refers to a quantity of times that the entity is linked by an entity mention extracted from the content database, that is, each time the content data in the content database is linked to an entity mention of the entity, it represents that the entity appears once. For example, if “Metro Line 13” appears twice in content data, and “Metro Line 13” is linked to an entity “Beijing Metro Line 13”, the entity “Beijing Metro Line 13” appears twice in the content data.

Specifically, after counting the quantity of occurrence times of the entity in the content database, for the entity mention linked to the entity, the computer device may add the quantity of occurrence times of each entity linked to the entity mention to obtain the counting quantity.

4. Calculate a ratio of the quantity of occurrence of the entity to the counting quantity, to obtain a confidence coefficient of the entity, and establishing a mapping relationship between the entity and the confidence coefficient.

The computer device may calculate the confidence coefficient by referring to the following formula (1):

P(e|m)=Freq(e,m)/Σ_{iϵE}Freq(eᵢ,m) (1)

P(e|m) is the confidence coefficient, and Freq(e, m) is the quantity of times that an entity e linked to an entity mention m appears in the content database.

In an embodiment, when an entity is linked to multiple entity mentions, for each entity mention, the computer device may calculate a confidence coefficient by using the formula (1), so that a mapping relationship between an entity, an entity mention, and a confidence coefficient may be established. In this case, when the confidence coefficient of the entity needs to be obtained, the entity mention on which currently entity linking needs to performed may be first determined, and a confidence coefficient that has a mapping relationship with the entity and the entity mention is determined as a confidence coefficient of the entity.

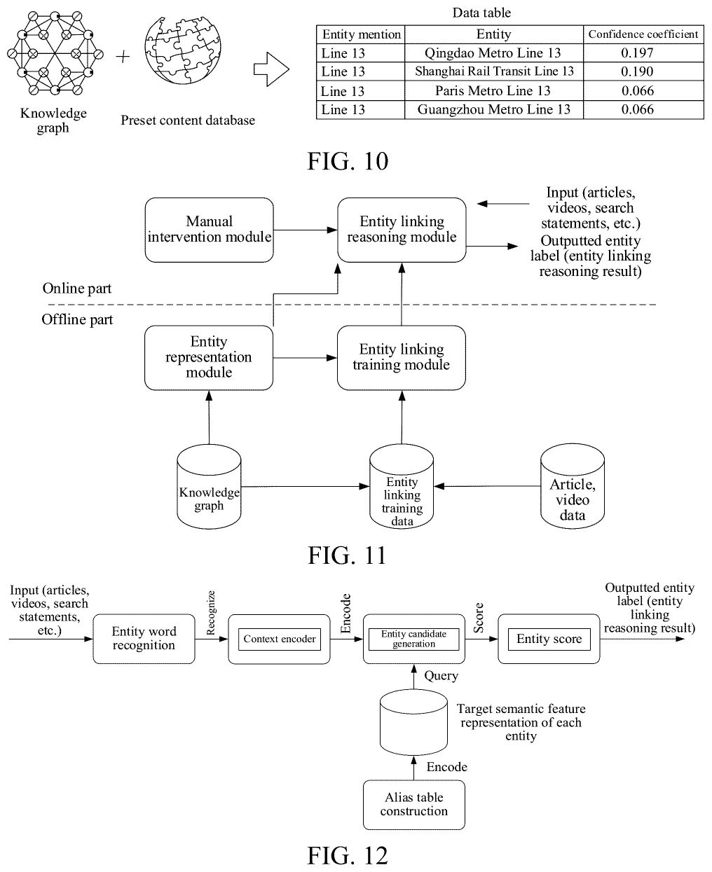

In a specific embodiment, FIG. 10 is a schematic diagram of establishing and storing a mapping relationship. In this embodiment, the mapping relationship is established based on a knowledge graph and a preset content database. The established mapping relationship may be stored in a form of a data table. There is a mapping relationship between an entity mention and an entity in each row of the data table, and there is a mapping relationship between an entity and a confidence coefficient.

In an embodiment, after the foregoing mapping relationship is established, the computer device may query the mapping relationship between the entity mention and the linked entity, so as to determine at least one candidate entity corresponding to the target entity mention, and may separately calculate a similarity between a context feature representation and a target semantic feature representation of each candidate entity, and multiply the similarity corresponding to each candidate entity by a corresponding confidence coefficient to obtain a respective confidence of each candidate entity. For details of confidence calculation, refer to the following formula (2):

Score(e,m)=P(e|m)Cos(Embₑ,Embₘ) (2)

Score(e, m) is the confidence, P(e|m) is the confidence coefficient, Embₑ is an embedding of the candidate entity, that is, the target semantic feature representation of the candidate entity, Embₘ is an embedding of the entity mention, that is, the target context feature representation, and Cos represents calculation of a cosine similarity.

In the foregoing embodiment, the mapping relationship between each candidate entity and a confidence coefficient is established in advance, so that when the confidence is calculated, the confidence coefficient can be obtained, so that a more accurate confidence can be obtained by means of calculation, and entity linking accuracy is further improved.

In a specific embodiment, a data processing method and an entity linking method are provided. An entity linking system that can be automatically updated and sensitive to a new entity can be constructed based on a continuously updated knowledge graph, and can be adapted to Chinese and multi-language knowledge graphs and corpus data, which plays an important role in text understanding, video understanding, and other multi-modal content understanding in enterprise-level data. In this embodiment, a semantic feature representation of an existing entity or a new entity is mainly constructed based on an entity encoder, and a vector representation of an entity word in a context is constructed based on a context encoder, so that multi-modal content such as a text and a video can be mapped to a semantic space of the existing entity or the new entity, so that an entity in a context can be accurately parsed, and ambiguity can also be well eliminated for the new entity.

FIG. 11 is a technical architecture diagram of an embodiment. FIG. 11 may be divided into an online part and an offline part. The online part includes a manual intervention module and an entity linking reasoning module, and the offline part includes an entity representation module and an entity linking training module. The following specifically describes the modules with reference to FIG. 11.

### 1. Entity Representation Module:

Based on a continuously updated knowledge graph, given an ID of any entity, this module constructs a semantic feature representation (entity embedding) of the entity from the knowledge graph. The semantic feature representation of the entity is a vector value, that is, embedding. The semantic feature representation includes the following parts:

1.1. An entity feature string (that is, the foregoing semantic feature data) generator: A name of the entity, a text description (if any), a main context segment (if any) in which the entity appears, and a relationship (if any) between the entity and another entity are obtained from the knowledge graph, and the foregoing data is concatenated to form a text feature string of the entity. The feature string has a flexible feature: (1) When the graph is updated, the feature string of the entity may be updated. (2) The feature string of the new entity does not depend on a large amount of training data for the new entity, but can be obtained only by using the name, description, or a small amount of context segment information of the new entity. (3) Manual intervention can be performed on the feature string in the manual intervention module. (4) Based on a generative language model, an entity feature string optimizer is trained, and a natural language feature string is generated based on a graph relationship structure.

1.2. Entity encoder (that is, the foregoing first entity encoding model): For a given entity feature string, a multi-layer attention encoder model based on a multilingual BERT (mBERT) structure is trained, and the given feature string is encoded as a vector in a semantic space to obtain an embedding of an entity. The encoder is initialized by mBERT or another pre-trained language model and is configured to obtain a unified encoding space represented by a multi-language entity. The entity encoder may be obtained by performing training by using the two-tower model shown in FIG. 5 or FIG. 6, and finally a trained entity encoder (that is, the trained first entity encoding model in the foregoing) is obtained. For a specific training process, refer to descriptions in the foregoing embodiment.

1.3. Optimization based on a graph structure: A full first-order relationship and a full second-order relationship of the entity are pulled from the knowledge graph, and a sub-graph is constructed for the involved entity. Each entity in the sub-graph may be initialized by using the semantic feature representation generated by the entity encoder that completes training in 1.2, and then data such as a text or a video that has an entity linking relationship with the entity is obtained to construct a training sample (that is, the foregoing second training sample). Further, the two-tower model in FIG. 7 may be trained. After the training is completed, a second entity encoding model is obtained. The second entity encoding model may optimize a value of an embedding of an entity outputted by the trained first entity encoding model.

2. Entity Linking Training Module, where the Module Includes Several Parts.

### 2.1 Construction of Training Data:

2.1.1 Strong supervised data Encyclopedia data or links in other linked corpus data are parsed, processed, and matched to obtain training data for a text-to-entity mapping.

2.1.2 Weak supervised data: An entity name that is not ambiguous in the knowledge graph is selected by using a rule, and a corpus such as article data and video data is accurately matched by using a name set, so as to obtain a mapping from a text to an entity.

### 2.2 Model Training:

A training sample (that is, the third training sample) is constructed based on the entity linking data set in 2.1, and a two-tower model is trained. In an initial training phase, the left tower is a context encoder (that is, the foregoing third context encoding model), and is initialized by using a mBERT model or another pre-trained language model. The right tower is an entity encoder, and may be the encoder in 1.2. After the training in 1.2 and 1.3 is completed, the embedding of each entity may be obtained. The right-tower data may be fixed as the embedding itself, and only the context encoder of the left tower is trained, so as to obtain an optimal application effect, and finally, a trained context encoder, that is, the foregoing third context encoding model, is obtained.

### 3. Entity Linking Reasoning Module

The module includes several offline or online sub-modules and can support offline or online reasoning application of entity linking. FIG. 12 is a schematic diagram of a reasoning process of an entity linking reasoning module. The following describes, with reference to FIG. 12, modules involved in entity linking.

### 3.1 Alias Table Construction Module:

Based on existing knowledge graph data, associated corpus data, such as a known mapping between encyclopedic data and a knowledge graph (that is, 2.1.1 “Strong supervised data”), an alias table from a mention (entity mention) to an entity is constructed based on a statistical method. The alias table is a data table configured for storing a mapping relationship between a mention and an entity, and a mapping relationship between an entity and a confidence coefficient P(e|m). For a calculation manner of P(e|m), refer to the foregoing formula (1). For an example of a constructed alias table, references may be made to FIG. 10. The alias table may be constructed periodically, so that a new entity of the knowledge graph has a certain exploration capability.

### 3.2 Entity Word Recognition Online Module:

The module is deployed as a front-end service to recognize an entity word for an inputted article, search statement, video, and the like. The service may perform entity word recognition in a manner of using a named entity recognition model, an alias table matching service (query the alias table generated in 3.1), manual template type matching, and the like, to obtain one or more entity words (mention, that is, the foregoing entity mention).

### 3.3 Context Encoder Module:

The third target context encoder trained in 2.2 is deployed as an online service by using a machine learning platform. An input to the module is the input received in 3.2, and an output is a context code (mention embedding) corresponding to an entity word, that is, a target context feature representation.

### 3.4 Entity Encoder Module:

Entity encoders (including the trained first entity encoding model and the trained second entity encoding model) trained by the entity representation model are deployed as a periodic encoding service, an entity feature representation (entity embedding) of any entity in a knowledge graph is calculated, and an entity ID and entity_embedding are deployed as online services, and are stored and periodically updated in an online key-value (KV) storage system. The trained entity encoder performs a periodic encoding operation on the knowledge graph entity, and stores a representation of a new entity in online storage in time, so as to achieve a sensitivity effect to the new entity.

### 3.5 Entity Candidate Generation Module:

This module is deployed as a front-end service. The output of the module in 3.2 is the input to this module. For each entity word (m) outputted in 3.2, the alias table generated in 3.1 is queried, and all candidate entities (e) hit by the alias table and corresponding scores P(e|m) are outputted.

### 3.6 Entity Scoring Module:

This module queries each candidate entity e outputted in 3.5, and queries its corresponding entity embedding (Embₑ) based on the online KV. Based on the mention embedding (Embₘ) outputted in 3.3, the product of the cosine similarity of the two and the confidence coefficient P(e|m) in the alias table is calculated as a candidate score. For details, refer to the foregoing formula (2): Finally, for each entity word, a candidate entity with a highest score is outputted as a target entity, that is, an entity linking result is obtained.

### 4. Manual Intervention Module

This module provides an entry to intervene the content P(e|m) of the alias table in time to change a result of the online entity linking for a specific entity and a specific vocabulary.

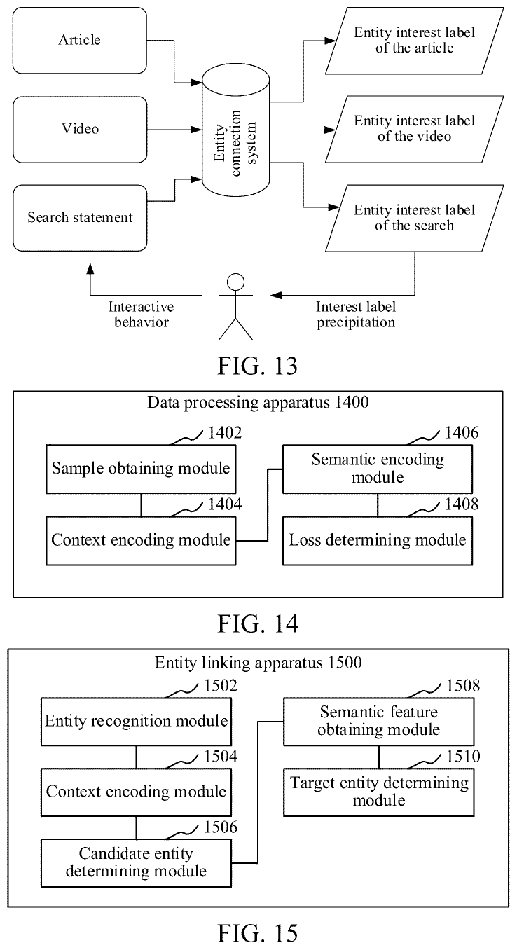

In a specific embodiment, an entity linking system that is configured for implementing the entity linking method in this disclosure may be constructed. The entity linking system may be configured for constructing a user interest label. Referring to FIG. 13, the entity linking system may be configured for performing entity linking on content such as an article, a video, or a search statement to recognize an interest label in the content. A user may be associated with the interest label by using the user's article behavior, video behavior, search behavior, and the like, to construct an entity interest portrait of the user, so as to assist in precise recommendation of the system, which may be configured for a recommendation system, an advertisement system, and the like.

In another specific embodiment, the entity linking method provided in this embodiment of this disclosure may be applied to content understanding of a search system, a recommendation system, an advertisement system, and the like. For content of a video, a commodity, an article, and the like, a trusted entity label is marked by using an entity link. The entity label may be configured for recommendation based on deep learning, an article feature in an advertisement system, a user article matching feature, and the like, thereby improving system recommendation accuracy.

In another specific embodiment, the entity linking method provided in this embodiment of this disclosure may be applied to an explicit label of a recommendation, search, or advertisement system. In a product scenario in which content such as a video or an article is recommended, searched, and advertised, a key entity in a text or a video may be parsed by using an entity link, and displayed as an explicit recommendation reason to a user, thereby improving stickiness and interaction experience of a recommendation system and improving commercial value.

Although the operations are displayed sequentially according to the instructions of the arrows in the flowcharts of the embodiments, these operations are not necessarily performed sequentially according to the sequence instructed by the arrows. Unless otherwise explicitly specified in this specification, execution of the operations is not strictly limited, and the operations may be performed in other sequences. Moreover, at least some of the operations in each embodiment may include multiple operations or multiple stages. The operations or stages are not necessarily performed at the same moment but may be performed at different moments. Execution of the operations or stages is not necessarily sequentially performed, but may be performed alternately with other operations or at least some of operations or stages of other operations.

Based on the same inventive concept, an embodiment of this disclosure further provides a data processing apparatus for implementing the foregoing involved data processing method and an entity linking apparatus for implementing the foregoing involved entity linking method. An implementation solution provided by the apparatus is similar to the implementation solution described in the foregoing method. Therefore, for a specific limitation in one or more data processing apparatuses and entity linking apparatus embodiments provided below, refer to the foregoing limitation on the data processing method and the entity linking method. Details are not described herein again.

In an embodiment, as shown in FIG. 14, a data processing apparatus 1400 is provided, including:
a sample obtaining module 1402, configured to obtain a first training sample, the first training sample including semantic feature data and training content data that are corresponding to a first training entity, the semantic feature data including semantic information of the first training entity, and the training content data including context information of the first training entity;
a context encoding module 1404, configured to encode the training content data by using a first context encoding model, to obtain a first context feature representation corresponding to the first training entity;
a semantic encoding module 1406, configured to encode the semantic feature data by using a to-be-trained first entity encoding model, to obtain a first semantic feature representation corresponding to the first training entity;
a loss determining module 1408, configured to: determine a first feature representation loss based on a similarity between the first context feature representation and the first semantic feature representation, and adjust a model parameter of the first entity encoding model based on the first feature representation loss to train the first entity encoding model.

In the foregoing data processing apparatus, because the entity encoding model determines the loss by using the context feature representation outputted by the context encoding model in the training process, the entity encoding model can not only learn of the semantic information, but also learn of the context information. Therefore, when the target entity encoding model is configured for generating a target semantic feature representation for an entity, a more accurate semantic feature representation may be obtained. In addition, when the semantic feature data inputted in the entity encoding model training process is obtained from the knowledge graph, the obtained semantic feature data is more flexible. When the knowledge graph is updated, the semantic feature data of the entity may be updated. The semantic feature representation of the new entity does not depend on a large quantity of training data for the new entity, and can be obtained only by using the semantic feature data of the new entity. Therefore, a continuously updated knowledge graph can be well adapted.

In an embodiment, when the training content data is a training text, the training text includes an entity mention corresponding to the first training entity. The context encoding module is further configured to: add a boundary mark to the entity mention in the training text to obtain a target training text; and input the target training text into the first context encoding model, and encode the target training text by using the first context encoding model, to obtain a context feature representation corresponding to the first training entity.

In an embodiment, the training content data is training data in multiple modals, and the training data in multiple modals includes at least two of a training text, a training video, or a training audio. The context encoding module is further configured to: separately input the training data in the multiple modals into the first context encoding model; separately encode the training data in the multiple modals by using the first context encoding model, to obtain content feature representations respectively corresponding to the multiple modals; and fuse the content feature representations respectively corresponding to the multiple modals to obtain a context feature representation corresponding to the first training entity.

In an embodiment, the foregoing apparatus further includes: a semantic feature representation generation module, configured to obtain a target knowledge graph, and determine, for a target entity of the target knowledge graph, an initial knowledge sub-graph including the target entity from the target knowledge graph; obtain, for each node in the initial knowledge sub-graph, semantic feature data corresponding to the node from the target knowledge graph, and input the semantic feature data corresponding to the node into a trained first entity encoding model, to obtain an initial semantic feature representation corresponding to the node; perform vector initialization on the initial knowledge sub-graph by using an initial semantic feature representation corresponding to each node, to obtain a target knowledge sub-graph; and encode the target knowledge sub-graph by using a trained second entity encoding model, to obtain a target semantic feature representation corresponding to the target entity.

In an embodiment, the foregoing apparatus further includes: an entity encoding model training module, configured to obtain a second training sample; the second training sample including a training knowledge sub-graph and training content data that are corresponding to the second training entity; and the training knowledge sub-graph being obtained by performing vector initialization on an initial knowledge sub-graph including the second training entity, and the initial knowledge sub-graph including the second training entity being determined from a knowledge graph in which the second training entity is located; encode, by using a second context encoding model, the training content data corresponding to the second training entity, to obtain a second context feature representation corresponding to the second training entity; encode the training knowledge sub-graph by using a to-be-trained second entity encoding model, to obtain a second semantic feature representation corresponding to the second training entity; and determine a second feature representation loss based on the second context feature representation and the second semantic feature representation, and adjust a model parameter of the to-be-trained second entity encoding model based on the second feature representation loss to obtain the trained second entity encoding model.

In an embodiment, the entity encoding model training module is further configured to: determine, for the second training entity, a knowledge sub-graph including the second training entity from the knowledge graph in which the second training entity is located, to obtain the initial knowledge sub-graph corresponding to the second training entity; obtain, for each node in the initial knowledge sub-graph corresponding to the second training entity, semantic feature data corresponding to the node from the knowledge graph in which the second training entity is located; input the semantic feature data corresponding to the node into the trained first entity encoding model, to obtain an initial semantic feature representation corresponding to the node; perform, by using an initial semantic feature representation corresponding to each node, vector initialization on the initial knowledge sub-graph corresponding to the second training entity, to obtain the training knowledge sub-graph corresponding to the second training entity; and construct the second training sample corresponding to the second training entity based on the training knowledge sub-graph corresponding to the second training entity and the training content data corresponding to the second training entity.

In an embodiment, the foregoing apparatus further includes: a context encoding model training module, configured to obtain a third training sample; the third training sample including training content data corresponding to a third training entity; the training content data corresponding to the third training entity including context information of the third training entity; encode, by using a to-be-trained third context encoding model, the training content data corresponding to the third training entity, to obtain a third context feature representation corresponding to the third training entity; determine a third feature representation loss based on the third context feature representation and a third semantic feature representation corresponding to the third training entity; the third semantic feature representation being obtained by encoding semantic feature data corresponding to the third training entity by using the trained first entity encoding model; and adjust a model parameter of the third context encoding model based on the third feature representation loss to train the third context encoding model.

In an embodiment, as shown in FIG. 15, an entity linking apparatus 1500 is provided, including:
an entity recognition module 1502, configured to: determine target content data, and perform entity recognition on the target content data to obtain a target entity mention;
a context encoding module 1504, configured to encode the target content data to obtain a target context feature representation corresponding to the target entity mention;
a candidate entity determining module 1506, configured to determine, based on a pre-established mapping relationship between an entity mention and an entity in a target knowledge graph, at least one candidate entity corresponding to the target entity mention;
a semantic feature obtaining module 1508, configured to obtain, for each candidate entity, a target semantic feature representation of the candidate entity, the target semantic feature representation being obtained based on an initial semantic feature representation, and the initial semantic feature representation being obtained by encoding, by using a trained first entity encoding model, semantic feature data corresponding to the candidate entity; and
a target entity determining module 1510, configured to: determine, based on a similarity between the target context feature representation and the target semantic feature representation of each candidate entity, a confidence of each candidate entity, and determine, based on the confidence of each candidate entity, a target entity corresponding to the target entity mention from the at least one candidate entity.

In the foregoing entity linking apparatus, target content data is determined, entity word recognition is performed on the target content data to obtain a target entity mention, and the target content data is encoded to obtain a target context feature representation corresponding to the target entity mention. At least one candidate entity corresponding to the target entity mention is determined based on a pre-established mapping relationship between an entity mention and an entity in a target knowledge graph. For each candidate entity, a target semantic feature representation of the candidate entity is obtained. A confidence of each candidate entity is determined based on a similarity between a target context feature representation and the target semantic feature representation of each candidate entity. A target entity corresponding to the target entity mention is determined from the at least one candidate entity based on the confidence of each candidate entity. Because the target context feature representation corresponding to the target entity mention can be obtained, the confidence is determined based on a similarity between the target context feature representation and the target semantic feature representation of each candidate entity, The target entity is determined according to the confidence. Therefore, in this disclosure, context information of the target content data can be fully considered during entity linking, and a more accurate target entity is obtained by matching the context information, thereby improving entity linking accuracy.

In an embodiment, the entity linking apparatus further includes: a semantic feature representation generation module, configured to determine a knowledge sub-graph including the candidate entity from the target knowledge graph, to obtain an initial knowledge sub-graph corresponding to the candidate entity; obtain, for each node in the initial knowledge sub-graph, semantic feature data corresponding to the node from the target knowledge graph; input the semantic feature data corresponding to the node into the trained first entity encoding model, to obtain an initial semantic feature representation corresponding to the node; perform vector initialization on the initial knowledge sub-graph by using an initial semantic feature representation corresponding to each node, to obtain a target knowledge sub-graph; and encode, by using a trained second entity encoding model, the target knowledge sub-graph obtained by means of initialization, to obtain the target semantic feature representation corresponding to the candidate entity.

In an embodiment, the entity linking apparatus further includes: a second entity encoding model training module, configured to obtain a second training sample; the second training sample including a training knowledge sub-graph and training content data that are corresponding to the second training entity; and the training knowledge sub-graph being obtained by performing vector initialization on an initial knowledge sub-graph including the second training entity, and the initial knowledge sub-graph including the second training entity being determined from a knowledge graph in which the second training entity is located; encode, by using a second context encoding model, the training content data corresponding to the second training entity, to obtain a second context feature representation corresponding to the second training entity; encode the training knowledge sub-graph by using a to-be-trained second entity encoding model, to obtain a second semantic feature representation corresponding to the second training entity; and determine a second feature representation loss based on the second context feature representation and the second semantic feature representation, and adjust a model parameter of the to-be-trained second entity encoding model based on the second feature representation loss to obtain the trained second entity encoding model.

In an embodiment, when the target content data is a text, the context encoding module is further configured to add a boundary mark to the target entity mention in the text to obtain a target text; and input the target text into the trained first context encoding model, and encode the target text by using the first context encoding model, so as to obtain the target context feature representation corresponding to the target entity mention.

In an embodiment, the context encoding module is further configured to input the target content data into a trained third context encoding model; and encode the target content data by using the third context encoding model, to obtain the target context feature representation corresponding to the target entity mention.

In an embodiment, the entity linking apparatus further includes: a third context encoding model training module, configured to obtain a third training sample; the third training sample including training content data corresponding to a third training entity; the training content data corresponding to the third training entity including context information of the third training entity; encode, by using a to-be-trained third context encoding model, the training content data corresponding to the third training entity, to obtain a third context feature representation corresponding to the third training entity; determine a third feature representation loss based on the third context feature representation and a third semantic feature representation corresponding to the third training entity; the third semantic feature representation being obtained by encoding semantic feature data corresponding to the third training entity by using the trained first entity encoding model; and adjust a model parameter of the third context encoding model based on the third feature representation loss to obtain the trained third context encoding model.

In an embodiment, the entity linking apparatus further includes: a mapping relationship establishing module, configured to extract multiple entity mentions from a preset content database; separately determine at least one entity linked to each entity mention from the target knowledge graph; count, for each entity linked to the entity mention, a quantity of occurrence of the entity in the content database; count, for an entity mention linked to the entity, a quantity of occurrence of each entity linked to the entity mention to obtain a counting quantity of the entity; and calculate a ratio of the quantity of occurrence of the entity to the counting quantity, to obtain a confidence coefficient of the entity, and establish a mapping relationship between the entity and the confidence coefficient.

In an embodiment, the target entity determining module 1510 is further configured to separately calculate the similarity between the target context feature representation and the target semantic feature representation of each candidate entity; and multiply the similarity corresponding to each candidate entity by a confidence coefficient corresponding to each candidate entity, to obtain the confidence of each candidate entity.

In an embodiment, the trained first entity encoding model is obtained through training based on a first feature representation loss, the first feature representation loss is determined based on a first context feature representation and a first semantic feature representation, the first context feature representation is obtained by encoding training content data by using a first context encoding model, the training content data belongs to a first training sample corresponding to a first training entity, the first training sample further includes semantic feature data corresponding to the first training entity, the first semantic feature representation is obtained by encoding the semantic feature data corresponding to the first training entity by using a to-be-trained first entity encoding model, and the training content data includes context information of the first training entity.

All or some of the modules in the foregoing data processing apparatus and the entity linking apparatus may be implemented by using software, hardware, and a combination thereof. The foregoing modules may be embedded in or independent of a processor in the computer device in a hardware form, or may be stored in a memory in the computer device in a software form, so that the processor invokes the software to execute operations corresponding to the foregoing modules.

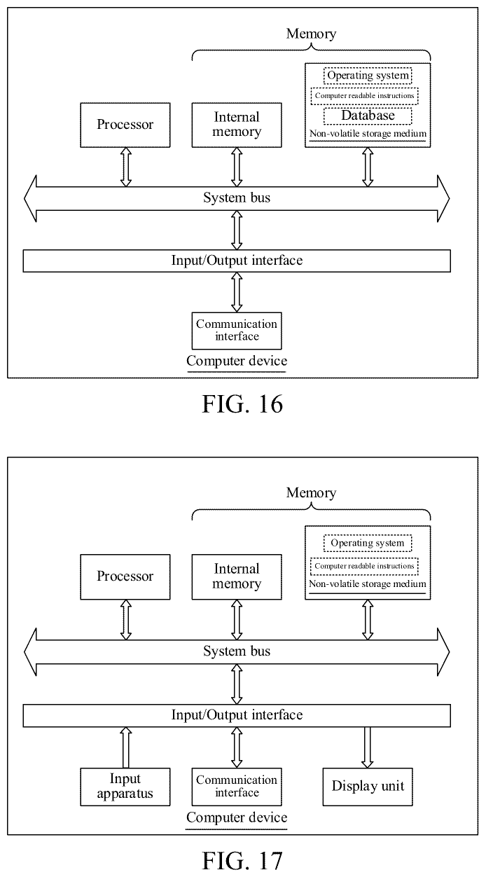

In an embodiment, a computer device is provided. The computer device may be a server, and an internal structure diagram of the computer device may be shown in FIG. 16. The computer device includes a processor (e.g., processing circuitry), a memory (e.g., a non-transitory computer-readable storage medium), an input/output (I/O), and a communication interface. The processor, the memory, and the input/output interface are connected to each other by using a system bus, and the communication interface is connected to the system bus by using the input/output interface. The processor of the computer device is configured to provide a computing and control capability. The memory of the computer device includes a non-volatile storage medium and an internal memory. The non-volatile storage medium stores an operating system, computer readable instructions, and a database. The internal memory provides an environment for running an operating system and computer readable instructions in the non-volatile storage medium. The database of the computer device is configured to store training sample data. The input/output interface of the computer device is configured to exchange information between the processor and an external device. The communication interface of the computer device is configured to communicate with an external terminal by using a model connection. The computer readable instructions are executed by the processor to implement a data processing method or an entity linking method.

In an embodiment, a computer device is provided. The computer device may be a terminal, and an internal structure diagram of the computer device may be shown in FIG. 17. The computer device includes a processor, a memory, an input/output interface, a communication interface, a display unit, and an input apparatus. The processor, the memory, and the input/output interface are connected to each other by using a system bus, and the communication interface, the display unit, and the input apparatus are connected to the system bus by using the input/output interface. The processor of the computer device is configured to provide a computing and control capability. The memory of the computer device includes a non-volatile storage medium and an internal memory. The non-volatile storage medium stores an operating system and computer readable instructions. The internal memory provides an environment for running an operating system and computer readable instructions in the non-volatile storage medium. The input/output interface of the computer device is configured to exchange information between the processor and an external device. The communication interface of the computer device is configured to communicate with an external terminal in a wired or wireless manner. The wireless manner may be implemented by using Wi-Fi, a mobile cellular model, a near field communication (NFC), or another technology. The computer readable instructions are executed by the processor to implement a data processing method or an entity linking method. The display unit of the computer device is configured to form a visual picture, and may be a display screen, a projection apparatus, or a virtual reality imaging apparatus. The display screen may be a liquid crystal display screen or an electronic ink display screen. The input apparatus of the computer device may be a touch layer covering the display screen, may be a key, a trackball, or a touchpad disposed on a housing of the computer device, or may be an external keyboard, touchpad, or mouse.

A person skilled in the art may understand that the structure shown in FIG. 16 or FIG. 17 is merely a block diagram of a partial structure related to the solutions of this disclosure, and does not constitute a limitation on the computer device to which the solutions of this disclosure are applied. A specific computer device may include more or fewer components than those shown in the figure, or combine some components, or have different component arrangements.

In an embodiment, a computer device is provided, including a memory and a processor, where the memory stores computer readable instructions, and the processor implements the foregoing data processing method or entity linking method when executing the computer readable instructions.

In an embodiment, a computer readable storage medium such as a non-transitory computer-readable storage medium is provided, having computer readable instructions stored therein. When the computer readable instructions are executed by a processor, the operations of the foregoing data processing method or entity linking method are implemented.

In an embodiment, a computer program product is provided, including computer readable instructions, and the computer readable instructions are executed by a processor to implement the operations of the foregoing data processing method or entity linking method.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A person of ordinary skill in the art may understand that all or some of procedures of the method in the foregoing embodiments may be implemented by computer readable instructions instructing relevant hardware. The computer readable instructions may be stored in a non-volatile computer readable storage medium. When the computer readable instructions are executed, the procedures of the foregoing method embodiments may be implemented. Any reference to a memory, a database, or another medium used in the embodiments provided in this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration but not a limitation, the RAM may be in multiple forms, such as a static random access memory (SRAM) or a dynamic random access memory (DRAM). The database involved in the embodiments provided in this disclosure may include at least one of a relational database and a non-relational database. The non-relational database may include a blockchain-based distributed database or the like, which is not limited thereto. The processor in the embodiments provided in this disclosure may be a general purpose processor, a central processing unit, a graphics processor, a digital signal processor, a programmable logic device, a quantum computing-based data processing logic device, or the like, which is not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments merely express several implementations of this disclosure. The descriptions thereof are relatively specific and detailed, but are not to be understood as limitations to the patent scope of this disclosure. For a person of ordinary skill in the art, several transforms and improvements can be made without departing from the idea of this disclosure. These transforms and improvements belong to the protection scope of this disclosure.

What is claimed is:

1. A data processing method, comprising:
receiving a first training sample, the first training sample including first semantic feature data associated with a first training entity and first training content data associated with the first training entity, the first semantic feature data including first semantic information of the first training entity, and the first training content data including first context information of the first training entity;
encoding the first training content data by using a first context encoding model to obtain a first context feature representation corresponding to the first training entity;
encoding the first semantic feature data by using a to-be-trained first entity encoding model to obtain a first semantic feature representation corresponding to the first training entity;
determining a first feature representation loss based on first similarity information between the first context feature representation and the first semantic feature representation; and
adjusting first model parameters of the to-be-trained first entity encoding model based on the first feature representation loss to obtain a trained first entity encoding model.

2. The method according to claim 1, wherein the first training content data includes first training text containing a first entity mention corresponding to the first training entity; and the encoding the first training content data comprises:
adding boundary markers to the first entity mention in the first training text to obtain first target training text; and
encoding the first target training text using the first context encoding model to obtain the first context feature representation.

3. The method according to claim 1, wherein the first training content data includes first training data in multiple modals, the first training data in the multiple modals including at least two types of data selected from first training text, a first training video, and a first training audio; and the encoding the first training content data comprises:
separately encoding the first training data in the multiple modals using the first context encoding model to obtain first content feature representations respectively corresponding to the multiple modals; and
fusing the first content feature representations respectively corresponding to the multiple modals to obtain the first context feature representation.

4. The method according to claim 1, further comprising:
receiving a target entity from a target knowledge graph;
identifying a target initial knowledge subgraph including the target entity from the target knowledge graph;
for each target node in the target initial knowledge subgraph,
extracting target semantic feature data corresponding to the respective target node from the target knowledge graph; and
inputting the target semantic feature data corresponding to the respective target node into the trained first entity encoding model to obtain a target initial semantic feature representation corresponding to the respective target node;
performing target vector initialization on the target initial knowledge subgraph using the target initial semantic feature representation corresponding to each target node to obtain a target knowledge subgraph; and
encoding the target knowledge subgraph using a trained second entity encoding model to obtain a target semantic feature representation corresponding to the target entity.

5. The method according to claim 4, wherein the trained second entity encoding model is obtained by:
receiving a second training sample including a second training knowledge subgraph associated with a second training entity and second training content data associated with the second training entity, the second training knowledge subgraph being obtained by performing second vector initialization on a second initial knowledge subgraph including the second training entity, and the second initial knowledge subgraph including the second training entity being determined from a knowledge graph located in the second training entity;
encoding the second training content data corresponding to the second training entity using a second context encoding model to obtain a second context feature representation corresponding to the second training entity;
encoding the second training knowledge subgraph by using a to-be-trained second entity encoding model to obtain a second semantic feature representation corresponding to the second training entity;
determining a second feature representation loss based on second similarity information between the second context feature representation and the second semantic feature representation; and
adjusting second model parameters of the to-be-trained second entity encoding model based on the second feature representation loss to obtain the trained second entity encoding model.

6. The method according to claim 5, wherein the receiving the second training sample comprises:
determining, for the second training entity, the second initial knowledge subgraph including the second training entity from the knowledge graph located in the second training entity;
for each second node in the second initial knowledge subgraph corresponding to the second training entity,
extracting second semantic feature data corresponding to the respective second node from the knowledge graph located in the second training entity; and
inputting the second semantic feature data corresponding to the respective second node into the trained first entity encoding model to obtain a second initial semantic feature representation corresponding to the respective second node;
performing the second vector initialization on the second initial knowledge subgraph using the second initial semantic feature representation corresponding to each second node to obtain the second training knowledge subgraph corresponding to the second training entity; and
constructing the second training sample based on the second training knowledge subgraph corresponding to the second training entity and the second training content data corresponding to the second training entity.

7. The method according to claims 1, further comprising:
obtaining a third training sample including third training content data corresponding to a third training entity, the third training content data corresponding to the third training entity including third context information of the third training entity;
encoding the third training content data corresponding to the third training entity using a to-be-trained third context encoding model to obtain a third context feature representation corresponding to the third training entity;
determining a third feature representation loss based on third similarity information between the third context feature representation and a third semantic feature representation corresponding to the third training entity, the third semantic feature representation being obtained by encoding third semantic feature data corresponding to the third training entity by using the trained first entity encoding model; and
adjusting third model parameters of the to-be-trained third context encoding model based on the third feature representation loss to obtain a trained third context encoding model.

8. An entity linking method, comprising:
determining target content data;
performing entity word recognition on the target content data to obtain a target entity mention;
encoding the target content data to obtain a target context feature representation corresponding to the target entity mention;
determining, based on a pre-established mapping relationship between an entity mention and an entity in a target knowledge graph, at least one candidate entity corresponding to the target entity mention;
obtaining, for each candidate entity, a target semantic feature representation corresponding to the respective candidate entity, the target semantic feature representation being obtained based on an initial semantic feature representation, and the initial semantic feature representation being obtained by encoding candidate semantic feature data of the respective candidate entity using a trained first entity encoding model;
determining a candidate confidence for each candidate entity based on target similarity information between the target context feature representation and the target semantic feature representation of each candidate entity; and
determining a target entity corresponding to the target entity mention from the at least one candidate entity based on the candidate confidence of each candidate entity.

9. The method according to claim 8, wherein the target semantic feature representation of the respective candidate entity is obtained by:
determining a candidate knowledge subgraph including the respective candidate entity from the target knowledge graph;
for each candidate node in the candidate knowledge subgraph,
extracting the candidate semantic feature data corresponding to the respective candidate node from the target knowledge graph; and
inputting the candidate semantic feature data corresponding to the respective candidate node into the trained first entity encoding model to obtain a candidate initial semantic feature representation corresponding to the candidate node;
performing candidate vector initialization on the candidate knowledge subgraph using the candidate initial semantic feature representation corresponding to each candidate node to obtain a target knowledge subgraph; and
encoding the target knowledge subgraph using a trained second entity encoding model to obtain the target semantic feature representation corresponding to the respective candidate entity.

10. The method according to claim 9, wherein the trained second entity encoding model is obtained by:
obtaining a second training sample including a second training knowledge subgraph associated with a second training entity and second training content data associated with the second training entity, the second training knowledge subgraph being obtained by performing second vector initialization on a second initial knowledge subgraph including the second training entity, and the second initial knowledge subgraph being determined from a knowledge graph located in the second training entity;
encoding the second training content data using a second context encoding model to obtain a second context feature representation corresponding to the second training entity;
encoding the second training knowledge subgraph using a to-be-trained second entity encoding model to obtain a second semantic feature representation corresponding to the second training entity;
determining a second feature representation loss based on second similarity information between the second context feature representation and the second semantic feature representation; and
adjusting second model parameters of the to-be-trained second entity encoding model based on the second feature representation loss to obtain the trained second entity encoding model.

11. The method according to claim 8, wherein the encoding the target content data comprises:
inputting the target content data into a trained third context encoding model; and
encoding the target content data using the trained third context encoding model to obtain the target context feature representation corresponding to the target entity mention.

12. The method according to claim 11, wherein the trained third context encoding model is obtained by:
receiving a third training sample including third training content data corresponding to a third training entity, the third training content data including third context information of the third training entity;
encoding the third training content data using a to-be-trained third context encoding model to obtain a third context feature representation corresponding to the third training entity;
determining a third feature representation loss based on third similarity information between the third context feature representation and a third semantic feature representation corresponding to the third training entity; the third semantic feature representation being obtained by encoding third semantic feature data corresponding to the third training entity using the trained first entity encoding model; and
adjusting third model parameters of the to-be-trained third context encoding model based on the third feature representation loss to obtain the trained third context encoding model.

13. The method according to claim 8, further comprising:
extracting multiple entity mentions from a preset content database;
determining at least one linked entity for each entity mention from the target knowledge graph;
counting occurrence numbers of each linked entity in the preset content database;
determining, for each entity mention linked to a linked entity, a count number by counting occurrence numbers of entities linked to the entity mention; and
calculating an entity confidence coefficient as a ratio of the occurrence numbers of the linked entity to the count number, and establishing a mapping relationship between the linked entity and the entity confidence coefficient.

14. The method according to claim 13, further comprising:
calculating the target similarity information between the target context feature representation and the target semantic feature representation of each candidate entity, wherein
the determining the candidate confidence includes multiplying the target similarity information of each candidate entity by the entity confidence coefficient corresponding to each candidate entity to determine the candidate confidence of each candidate entity.

15. The method according to claim 8, wherein the trained first entity encoding model is obtained by:
receiving a first training sample, the first training sample including first semantic feature data associated with a first training entity and first training content data associated with the first training entity, the first semantic feature data including first semantic information of the first training entity, and the first training content data including first context information of the first training entity;
encoding the first training content data by using a first context encoding model to obtain a first context feature representation corresponding to the first training entity;
encoding the first semantic feature data by using a to-be-trained first entity encoding model to obtain a first semantic feature representation corresponding to the first training entity;
determining a first feature representation loss based on first similarity information between the first context feature representation and the first semantic feature representation; and
adjusting first model parameters of the to-be-trained first entity encoding model based on the first feature representation loss.

16. An apparatus, comprising:
processing circuitry configured to:
receive a first training sample, the first training sample including first semantic feature data associated with a first training entity and first training content data associated with the first training entity, the first semantic feature data including first semantic information of the first training entity, and the first training content data including first context information of the first training entity;
encode the first training content data by using a first context encoding model to obtain a first context feature representation corresponding to the first training entity;
encode the first semantic feature data by using a to-be-trained first entity encoding model to obtain a first semantic feature representation corresponding to the first training entity;
determine a first feature representation loss based on first similarity information between the first context feature representation and the first semantic feature representation; and
adjust first model parameters of the to-be-trained first entity encoding model based on the first feature representation loss to obtain a trained first entity encoding model.

17. The apparatus according to claim 16, wherein the first training content data includes first training text containing a first entity mention corresponding to the first training entity; and the processing circuitry is configured to:
add boundary markers to the first entity mention in the first training text to obtain first target training text; and
encode the first target training text using the first context encoding model to obtain the first context feature representation.

18. The apparatus according to claim 16, wherein the first training content data includes first training data in multiple modals, the first training data in the multiple modals including at least two types of data selected from first training text, a first training video, and a first training audio; and the processing circuitry is configured to:
separately encode the first training data in the multiple modals using the first context encoding model to obtain first content feature representations respectively corresponding to the multiple modals; and
fuse the first content feature representations respectively corresponding to the multiple modals to obtain the first context feature representation.

19. The apparatus according to claim 16, wherein the processing circuitry is configured to:
receive a target entity from a target knowledge graph;
identify a target initial knowledge subgraph including the target entity from the target knowledge graph;
for each target node in the target initial knowledge subgraph,
extract target semantic feature data corresponding to the respective target node from the target knowledge graph; and
input the target semantic feature data corresponding to the respective target node into the trained first entity encoding model to obtain a target initial semantic feature representation corresponding to the respective target node;
perform target vector initialization on the target initial knowledge subgraph using the target initial semantic feature representation corresponding to each target node to obtain a target knowledge subgraph; and
encode the target knowledge subgraph using a trained second entity encoding model to obtain a target semantic feature representation corresponding to the target entity.

20. The apparatus according to claim 19, wherein the processing circuitry is configured to:
receive a second training sample including a second training knowledge subgraph associated with a second training entity and second training content data associated with the second training entity, the second training knowledge subgraph being obtained by performing second vector initialization on a second initial knowledge subgraph including the second training entity, and the second initial knowledge subgraph including the second training entity being determined from a knowledge graph located in the second training entity;
encode the second training content data corresponding to the second training entity using a second context encoding model to obtain a second context feature representation corresponding to the second training entity;
encode the second training knowledge subgraph by using a to-be-trained second entity encoding model to obtain a second semantic feature representation corresponding to the second training entity;
determine a second feature representation loss based on second similarity information between the second context feature representation and the second semantic feature representation; and
adjust second model parameters of the to-be-trained second entity encoding model based on the second feature representation loss to obtain the trained second entity encoding model.
